(19) United States
(12) Patent Application Publication
(10) Pub. No.: US 2015/0100443 A1
(43) Pub. Date: Apr. 9, 2015

(54) Systems and Methods for Providing Enhanced Point-Of-Sale Services Involving Multiple Financial Entities

(71) Applicants: Lauren VAN HEERDEN, Bedford, NH (US); Gunalan NADARAJAH, Milton, CA (US); Orin DEL VECCHIO, Richmond Hill, CA (US); Michael D. CUMMINS, Pickering, CA (US); Prabaharan SIVASHANMUGAM, Farmington Hills, MI (US)

(72) Inventors: Lauren VAN HEERDEN, Bedford, NH (US); Gunalan NADARAJAH, Milton, CA (US); Orin DEL VECCHIO, Richmond Hill, CA (US); Michael D. CUMMINS, Pickering, CA (US); Prabaharan SIVASHANMUGAM, Farmington Hills, MI (US)

(73) Assignee: The Toronto-Dominion Bank, Mississauga (CA)

(21) Appl. No.: 14/510,873

(22) Filed: Oct. 9, 2014

Related U.S. Application Data
(60) Provisional application No. 61/888,621, filed on Oct. 9, 2013.

(51) Int. Cl. G06Q 20/22; G06Q 20/20

(52) U.S. Cl. CPC G06Q 20/227; G06Q 20/20; G06Q 20/204; G06Q 40/025
USPC 705/16

(57) ABSTRACT

Systems and methods are provided for identifying enhanced services for presentation to a user at a point-of-sale terminal. The disclosed embodiments include, for example, a system that may be configured to receive a request to authenticate a purchase transaction that identifies a financial service account and a point-of-sale terminal. The system may be configured to determine an issuer of the user's account and to obtain, from the issuer, information identifying one or more first services offered by the issuer. The server may be further configures to transmit, to a point-of-sale device, information identifying the at least one of the first services available to the user

### CROSS-REFERENCE TO RELATED APPLICATIONS

This application claims the benefit of priority to U.S. Provisional Patent Application No. 61/888,621, filed Oct. 9, 2013, the disclosure of which is incorporated herein by reference to its entirety.

### BACKGROUND

1. Technical Field

The present disclosure generally relates to systems and methods for performing financial transactions in a network environment, such as the Internet. More particularly, and without limitation, the present disclosure relates to systems and methods that identify available services for presentation to customers at point-of-sale terminals.

2. Background

Today, increased speed and availability of data networks has made many forms of information more accessible than ever. However, devices connected to networks, such as the Internet, may not be utilized in a manner that provides a timely and pertinent provision of ancillary services in retail settings. While network-connected devices are used to facilitate and authorize sales transactions, they are often not equipped to provide to useful financial information and services across the data networks of multiple financial service providers. Accordingly, there is a need for greater interconnection and application of customer information to provide enhanced user services at the point-of-sale.

### SUMMARY

The disclosed embodiments include computerized methods and systems for identifying one or more enhanced issuer-based services available to a user of a financial institution, and for providing information identifying the available services to a point-of-sale terminal.

The disclosed embodiments include, for example, a computer-implemented method that receives, by one or more processors, first information identifying an account of a user and second information identifying a point-of-sale terminal. The method also includes determining, by the one or more processors, based on the first and second information, whether an issuer of the user account corresponds to a provider of the point-of-sale terminal, and when the issuer fails to correspond to the provider, requesting, by the one or more processors, and from a server associated with the issuer, third information associated with a plurality first services offered by the issuer. The method identifies identifying, by the one or more processors, the first services available to the user, based upon the third information. In some aspects, the assigning includes assigning rankings to the available first services based on at least one of the third information or profile data corresponding to the user. The method includes selecting, by the one or more processors, and based on the assigned ranking, at least one of the available first services for transmission to the point-of-sale terminal, and generating, by the one or more processors, an electronic command to transmit, to the point-of-sale terminal, information identifying the selected available first services.

The disclosed embodiments also include a system having a storage device and at least one processor coupled to the storage device. The storage device may store software instructions for controlling the at least one processor when executed by the at least one processor. In one embodiment, the at least one processor may be operative with the software instructions and may be configured to receive first information identifying an account of a user and second information identifying a point-of-sale terminal, and determine, based on the first and second information, whether an issuer of the user account corresponds to a provider of the point-of-sale terminal. The at least one processor ay be configured to, when the issuer fails to correspond to the provider, request, from a server associated with the issuer, third information associated with a plurality of first services offered by the issuer. The at least one processor may be configured to identify the first services available to the user, based upon the third information, and assign rankings to the available first services, based on at least one of the third information or profile data corresponding to the user. The at least one processor is further configured to select at least one of the available first service based on the assigned rankings, and generate an electronic command to transmit, to the point-of-sale terminal, information identifying the selected available first service.

In additional embodiments, a device includes a display unit, a storage device, and at least one processor coupled to the display unit and storage device. The storage device may store software instructions for controlling the at least one processor when executed by the at least one processor. The at least one processor is operative with the software instructions and is configured to receive, from a system associated with a provider of the device, information identifying a plurality of services available to a user. In one aspect, the available services may be identified based on at least one of a payment instrument of the user, a purchase transaction involving the payment instrument, or a profile of the user. In other aspects, the available services include at least a first service identified by the provider system and a second service identified by a system associated with an issuer of the payment instrument. The at least one processor may be further configured to generate a first electronic command to present, to the user on the display device, data identifying a portion of the available services. The at least one processor may be further configured to generate a second electronic instruction to modify a visual characteristic of the displayed data corresponding one or more of the available services in accordance with a characteristic of a communications network interconnecting the device and the provider system. The at least one processor may be further configured to receiving, from the user, a selection of at least one of the available services, and generate a third electronic command to transmit information identifying the selected at least one available services to the provider system across the communications network.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a diagram of an exemplary computing environment consistent with disclosed embodiments.

FIG. 2 is a diagram of an exemplary computer system, consistent with disclosed embodiments.

FIG. 3 is a depiction of an exemplary interface at a point-of-sale terminal, according to disclosed embodiments.

FIG. 4 is a flowchart of an exemplary method for identifying and providing services at a point-of-sale terminal, in accordance with disclosed embodiments.

FIGS. 5-13 illustrate exemplary services provided to users by point-of-sale (POS) terminals, in accordance with disclosed embodiments.

### DESCRIPTION OF THE EMBODIMENTS

Reference will now be made in detail to embodiments of the present disclosure, examples of which are illustrated in the accompanying drawings. The same reference numbers will be used throughout the drawings to refer to the same or like parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

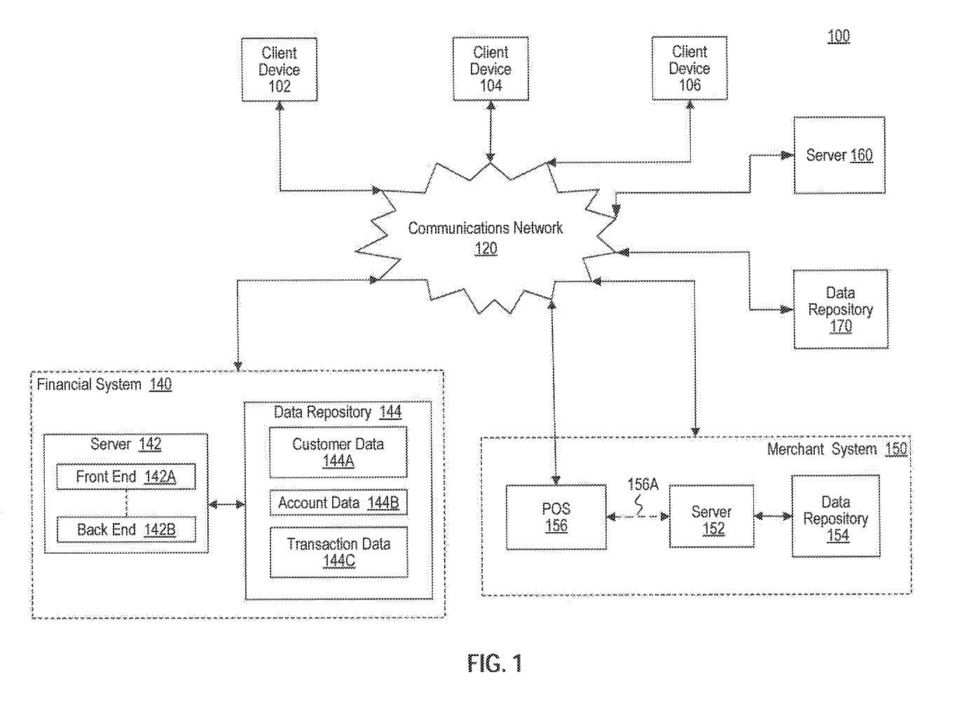

FIG. 1 illustrates an exemplary computing environment 100, consistent with certain disclosed embodiments. In one aspect, system 100 may include a financial transaction system 140, a merchant system 150, a server 160, a data repository 170, and one or more client devices 102, 104, and 106 that may be interconnected via a communications network 120.

In one embodiment, financial transaction system 140 may be one or more computer systems associated with a financial institution, such as, for example, a commercial bank, an investment bank, a broker-dealer, a provider of a payment instrument and financial service accounts, etc. In some embodiments, a financial service account may be a check, savings, credit, debit, and/or a reward or loyalty account. In one embodiment, a payment instrument may include, but is not limited to, a personal or corporate credit card, a debit card, a prepaid credit or debit card, check instruments. These transactions include, but are not limited to, a transfer of funds between financial accounts (e.g., checking, savings, investment, etc.), a payment of a bill, a purchase or sale of a financial instrument or security, a deposit or withdrawal of funds, or an application for credit.

In certain embodiments, financial transaction system 140 may include a server 142 and a data repository 144. Server 142 may be, for example, a transaction server and may include a front end 142A, and a back end 142B disposed in communication with front end 142A, although the configuration of server 142 is not limited to such configurations. For exemplary purposes only, server 142 may be referred to as a transaction server 142. In one example, front end 142A and back end 142B of transaction server 142 may be incorporated into a single computer, a single server, or any additional or alternate computing device apparent to one or skill in the art. In other embodiments, front end 142A and backend 142B may be distributed computing devices. Further, in one embodiment, front end 142A may be one or more software programs, such as a software application (e.g., a web service) executing on transaction server 142. Similarly, backend 142B may be one or more software programs executing on transaction server 142. However, transaction server 142 is not limited to such configurations, and, in additional embodiments, front end 142A can be executed on any computer or server separate from back end 142B.

Transaction server 142 may be configured to execute software instructions to perform one or more processes consistent with the disclosed embodiments. In one embodiment, and client devices 102, 104, and 106 may exchange information and parameters that facilitate an execution of one or more transactions by financial transaction system 140.

Data repository 144 may be one or more data storages configured to store information consistent with the disclosed embodiments. In one aspect, data repository may include customer data 144A, account data 144B, and transaction data 144C. In one aspect, customer data 144A may include one or more data records that uniquely identify one or more customers of a financial institution associated with transaction system 140. By way of example, a customer of the financial institution may access a web page associated with transaction system 140 (e.g., through a web server executed by front end 142A), and may subsequently register for online banking services and provide data, which may be linked to the customer and stored within customer data 144A.

In certain aspects, customer data 144A may include personal information associated with a customer (e.g., a customer name, a home address, a date of birth, government-issued identifiers (e.g., drivers license numbers and Social Security numbers), employment information (e.g., employer name and address), and contact information (e.g., email addresses, home numbers, work numbers, and mobile numbers). Customer data 144A may also include one or authentication credentials associated with registered customers of the financial institution. For example, the authentication credentials may include, but are not limited to, a user name, a user-specified password, a system-generated password, or an alphanumeric identification number (e.g., a personal identification number (PIN)) specified by the user or assigned by financial transaction system 140. Other types of customer information may be stored and used by the disclosed embodiments.

Additionally or alternatively, customer data 144A may include information facilitating enhanced authentication techniques. For example, customer data 144A may store information identifying a security question associated with the customer (e.g., “What is your mother's maiden name?”) and the customer's registered answer to that security question. Customer data 144A may also include information identifying a particular security image or avatar selected by the user and displayed by the user during the authentication process.

Further, in one embodiment, customer data 144A may include user device identification information that identifies one or more devices registered to the user. In one embodiment, the user may provide the user device identification information (e.g., a mobile telephone number provided by the user when registering for online banking services), or alternatively, transaction server 142 may be configured to execute processes that automatically collect user device identification information (e.g., collecting an Internet Protocol (IP) address associated with the customer's smartphone).

Customer data 144A may also include data that enables transaction server 142 to target content to one or more users (e.g., customers of the financial institution associated with financial transaction system 140), or alternatively, to identify a peer group of users (e.g., a group of customers) having interests similar to those of a particular user (e.g., a particular customer). For example, such data may include, but is not limited to, demographic data associated with the group of users (e.g., age group, educational level, income level), social networking data (e.g., “handles” and links to one or more social networking sites), profile data indicating specific interests, and any additional or alternate data that appropriate to the customers and transaction server 142.

In certain aspects, account data 144B may include account identification information identifying one or more accounts of customers of the financial institution associated with financial transaction system 140. In one embodiment, account identification information may include financial service account information, such as, for example, a checking account, a savings account, a revolving credit line, an account linked to a credit or debit card, a brokerage account, and any additional or alternate account provided or supported by the financial institution. In other embodiments, account data 144B may include information identifying investment portfolios held by one or more customers of the financial institution (e.g., positions in one or more securities held by the customers). In other aspects, account data 144B may include account information associated with non-financial service accounts, such as membership accounts for certain services or activities (e.g., gym membership, prescription drug information, library card, employment identification, student account information, etc.)

In such embodiments, information within account data 144B may identify, for a single customer, one or more accounts associated with the customer and account data corresponding to the accounts (e.g., account, expiration date information, and/or card security codes, account balance information, and/or credit limit information).

Transaction data 144C may include information identifying one or more transactions that involve one or more customers of the financial institution associated with financial transaction system 140, and additionally or alternatively, one or more accounts of the one or more customers of the financial institution. In one embodiment, such transactions may include, but are not limited to, purchase transactions (e.g., purchases of goods and/or services from electronic or physical retailers), financial service transactions (e.g., fund transfers (e.g., between accounts)), bill payment transactions (e.g., electronic bill payment transactions), purchases or sales of financial instruments or securities, a deposit or withdrawal of funds, or an application for credit from the financial institution or other entity.

For example, financial transaction system 140 may be configured to execute software instructions that provide an digital financial service portal that enables a customer to access a web page of the financial institution to perform financial service type transactions. For instance, financial transaction system 140 may provide an digital banking portal that enables a customer to transfer funds from a first customer account to a second customer account, to schedule automatic bill payment services (e.g., select an amount and periodic payment date for making payments to an identified payee from the customer's selected financial account), and to schedule or perform other known types of online financial service processes. For instance, transaction server 142 may generate a data record within transaction data 144C that corresponds to the particular service initiated by the customer, such as an initiated transfer of funds, and may populate the data record with information associated with the initiated transaction. As an example, transaction information for a funds transfer may include, but is not limited to, a unique identifier associated with the fund transfer transaction, a timestamp of the transaction, and transaction parameter information (e.g., a source account, a target account, a transaction date, and an amount of transfer).

In certain embodiments, the data record within transaction data 144C may also include an identifier indicative of a status of the initiated funds transfer transaction. For instance, the digital banking portal may enable the customer to initiate the funds transfer transaction, and to provide transaction parameter information used to successfully execute the funds transfer transaction (e.g., information identifying a source account, a target account, a transaction date, and an amount of transfer).

For example, upon specification of the transaction parameter information, transaction server 142 may assign a status of “In Progress” to the initiated transaction, and may store a corresponding identifier of the status within the data record. Further, upon successful execution of the initiated transaction, transaction server 142 may update the status identifier stored within the data record to reflect the completed execution. Additionally or alternatively, upon cancellation of the initiated transaction (e.g., based on a customer request or upon expiration of a time-out period), transaction server 142 may update the status identifier stored within the data record to reflect the cancellation of the initiated transaction.

In further embodiments, the initiated transaction may be “interrupted” prior to execution by transaction server 142. For example, as described below, transaction server 142 may interrupt the execution of an initiated transaction to identify and offer customized services and/or products to a user at a point-of-sale (POS) terminal. In one embodiment, transaction server 142 may assign a status of “interrupted” to the initiated transaction and may update the status identifier stored within the data record to reflect the interrupted state.

Merchant system 150 may be one or more computer systems associated with a business entity that provides products and/or services. In one example, merchant system 150 may be associated with a retailer having one or more physical retail locations disposed within a geographic area (i.e., a “physical retailer”). Merchant system 150 may be a retailer that provides electronic or e-commerce type retail services. In one example, merchant system 150 may be an electronic or an e-commerce retailer that interacts with consumers through corresponding web interfaces or retailer-specific application programs (e.g., mobile “apps”). In one embodiment, one or more client devices 102, 104, and 106 may exchange information with merchant system 150 to purchase one or more goods and/or services using various payment instruments, and merchant system 150 may exchange information with financial transaction system 140 to obtain authorization for such purchase instruments, e.g., using a point-of-sale module described below.

Merchant system 150 may include, in one example, a merchant server 152, a data repository 154, and point-of-sale (POS) module 156. Although not depicted in FIG. 1, merchant server 152 may include a front end and a back end disposed in communication with the front end. In an embodiment, the front and back ends may be incorporated into a hardware unit, for example, a single computer, a single server, or any additional or alternate computing device apparent to one or skill in the art. In other embodiments, the front end may be a software application, such as a web service, executing on merchant server 152. However, merchant server 152 is not limited to such configurations, and, in additional embodiments, the front end may be executed on any computer or server separate from the back end.

Data repository 154 may be one or more storage devices that store information consistent with the disclosed embodiments. In one aspect, data repository 154 may store customer data that uniquely identifies and profiles one or more customers of the merchant associated with merchant system 150, and transaction data identifying one or more purchase transactions involving one or more customers of the merchant. Further, in such embodiments, data repository 154 also includes elements of electronic content that may be delivered to customers of the merchant, including, but not limited to, images and corresponding text describing goods and services sold by the merchant, one or more advertisements that could be delivered to the customers, or one or more rewards that could be provided to the customer.

In one embodiment, POS 156 may be one or more point of sale devices configured to perform known point of sale processes. A POS 156 may be disposed at a physical location in a merchant location associated with merchant system 150, such as a location where a customer may provide payment for goods and/or services (e.g., at a cash register at the merchant). The disclosed embodiments are not limited to such physical POS modules, and in additional embodiments, POS 156 may be a software module executed by merchant server 152, servers 142 or 160, or one or more of client devices 102, 104, and 106. Further, in certain embodiments, POS 156 may represent a device communicatively coupled to one or more of client device 102, 104, and 106 (e.g., a Square™) to provide mobile point-of-sale and payment services. POS 156 may also be a tablet, smart phone or similar devices that are configured to perform point-of-sale transactions consistent with the disclosed embodiments.

In some embodiments, a communications link 156 may facilitate communications between POS 156 and merchant server 152. Communications link 156A may include, but is not limited to, a wired cable connection, a wireless connection, a Bluetooth connection, and/or a near field communication (NFC) connection. Additionally or alternatively, POS 156 may communicate with merchant server 152, server 160, and financial transaction system 140 across network 120 using any of a number of communications protocols, which include, but are not limited to, hypertext transfer protocol (HTTP) and transmission control protocol/internet protocol (TCP/IP).

Further, in an embodiment, POS 156 may communicate across network 120 with a system associated with a “provider” of POS 156. For instance, the provider of POS 156 may provide content and other information for display on POS 156, and further, may process and direct messages from POS 156 to various networked components of environment 100 (e.g., server 160, which may be associated with an issuer of a payment instrument). In one embodiment, a financial institution associated with financial transaction system 140 may represent the provider of POS 156, and in such embodiments, a server associated with the financial institution (e.g., transaction server 142 of FIG. 1) may transmit data for display to POS 156.

Client devices 102, 104, and 106 may each reflect a computing device associated with a user (e.g., a customer of the merchant and/or the financial institution disclosed above). In certain aspects, client devices 102, 104, and 106 can include, but are not limited to, a personal computer, a laptop computer, a tablet computer, a notebook computer, a hand-held computer, a personal digital assistant, a portable navigation device, a mobile phone, a smart phone, a set top box, a third party portals, an optical disk player (e.g., a DVD player), a digital video recorder (DVR), and any additional or alternate computing device operable to transmit and receive data across network 120.

Further, although computing environment 100 is illustrated in FIG. 1 with three client devices 102, 104, and 106 in communication with transaction system 140, persons of ordinary skill in the art will recognize that environment 100 may include any number of number of mobile or stationary client devices, and any additional number of computers, systems, or servers without departing from the spirit or scope of the disclosed embodiments. Further, although computing environment 100 is illustrated in FIG. 1 with a single merchant system 150, a single transaction system 140, a single server 160, and a single external data repository 170, persons of ordinary skill in the art will recognize that environment 100 may include any number of additional number of merchant and financial systems, any number of additional number of servers and data repositories, and any additional number of computers, systems, servers, or server farms without departing from the spirit or scope of the disclosed embodiments.

Communications network 120 may represent any form or medium of digital data communication. Examples of communication network 120 include a local area network (“LAN”), a wireless LAN, a RF network, a Near Field Communication network, e.g., a “WiFi” network, a wireless Metropolitan Area Network (MAN) that connects multiple wireless LANs, and a wide area network (“WAN”), e.g., the Internet. Consistent with embodiments of the present disclosure, network 120 can include the Internet and include any publicly accessible network or networks interconnected via one or more communication protocols, including, but not limited to, hypertext transfer protocol (HTTP) and transmission control protocol/internet protocol (TCP/IP). Moreover, communications network 120 may also include one or more mobile device networks, such as a GSM network or a PCS network, that allow client devices, such as client device 102, to send and receive data via applicable communications protocols, including those described above.

In one embodiment, one or more of transaction server 142 and merchant server 152 may include a general purpose computer (e.g., a personal computer, network computer, server, or mainframe computer) having one or more processors that may be selectively activated or reconfigured by a computer program. In additional embodiments, one or more of transaction server 142 and merchant server 152 may be incorporated as corresponding nodes in a distributed network, and additionally or alternatively, as corresponding networked servers in a cloud-computing environment. Furthermore, transaction server 142 and merchant server 152 may communicate via network 120 with one or more additional servers (not shown), which facilitate the distribution of processes for parallel execution by the additional servers. In certain aspects, transaction server 142 and/or merchant server 152 may execute software instructions that perform one or more processes consistent with the disclosed embodiments.

Server 160 may be a computing device that provides information to one or more other components of computing environment 100. In one embodiment, server 160 may include a general-purpose computer (e.g., a personal computer, network computer, server, or mainframe computer) having one or more processors that may be selectively activated or reconfigured by a computer program. In one aspect, server 160 may be configured to provide one or more websites associated with an advertiser and/or content provider network. Further, upon request from a client device (e.g., client device 102), server 160 may be configured to provide information associated with a requested web page over communications network 120 to client device 102, which may render the received information and present the web page to a customer. Additionally, server 160 may be incorporated as a corresponding node in a distributed network, and additionally or alternatively, as a corresponding networked server in a cloud-computing environment. Furthermore, server 160 may communicate via network 120 with one or more additional servers (not shown), which may facilitate the distribution of processes for parallel execution by the additional servers.

Data repository 170 may be one or more storages that store information provided by or used by one or more components of computing environment 100. In one aspect, data repository may be incorporated into a single hardware unit, for example, a single computer or a single server. In such an embodiment, data repository 170 may include one or more storage mediums or storage devices. However, data repository 170 is not limited to such configurations, and, in additional embodiments, data repository 170 may reside on any additional or alternate computer or server accessible to transaction server 142, merchant server 152, and client devices 102, 104, and 106 over network 120.

In one aspect, data repository 170 may include a cloud-based data repository accessible to merchant system 150, financial system 140, server 160, and client devices 102, 104, and 106 across network 120 using any of the communications protocols outlined above. In some instances, cloud-based data repository 170 may be configured to store elements of customer, account, and/or transaction data (e.g., as described above) in data structures linked to information identifying corresponding users (e.g., user names, alphanumeric identifiers, PINs, etc.). For example, cloud-based data repository 170 may include data structures that link a particular user to one or more payments instruments held by the user at the financial institution associated with financial system 140 (e.g., credit card accounts, debit card accounts, rewards and/or loyalty accounts, etc.), and additionally or alternatively, at other financial institutions and business entities. Further, in other instances, cloud-based data repository 170 may store information identifying customized services, offers, and rewards presented to the users at POS terminals (e.g., POS 156), and additionally, data records indicating a history of services, offers, and/or rewards accepted and rejected by the users.

Additionally, by way of example, cloud-based data repository 170 may include data records that identify, for one or more users, pending or interrupted transactions, outstanding applications for credit at the financial institution, and/or requests to establish financial service accounts with the financial instruction that require completion. In some instances, the pending or interrupted transaction may include an interrupted purchase transaction initiated a POS of a merchant (e.g., POS 156 of merchant system 150). Further, for instance, the outstanding applications may include an online application for a credit card issued by the financial institution that requires a final authentication before processing and decision by the financial institution, and additionally or alternatively, the outstanding requests may include a request to establish checking account that requires a final know-your-client (KYC) authentication.

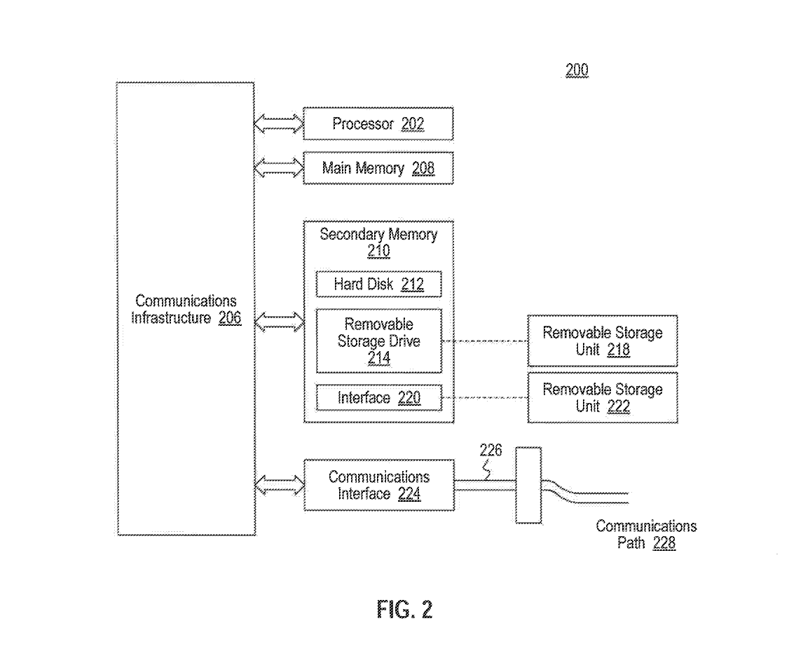

FIG. 2 is an exemplary computer system 200 with which embodiments consistent with the present disclosure may be implemented. In one aspect, computer system 200 may reflect the computer systems associated with server 142, server 152, server 160, client devices 102, 104, and/or 106. In certain embodiments, computer system 200 may include one or more processors, such as processor 202. Processor 202 may be connected to a communication infrastructure 206, such as a bus or communications network, e.g., network 120 of FIG. 1.

Computer system 200 may also include a main memory 208, for example, random access memory (RAM), and may include a secondary memory 210. Secondary memory 210 may include, for example, a hard disk drive 212 and/or a removable storage drive 214, representing a magnetic tape drive, an optical disk drive, CD/DVD drive, etc. The removable storage drive 214 reads from and/or writes to a removable storage unit 218 in a well-known manner. Removable storage unit 218 may represent a magnetic tape, optical disk, or other storage medium that is read by and written to by removable storage drive 214. As will be appreciated, the removable storage unit 218 can represent a computer-readable medium having stored therein computer programs, sets of instructions, code, or data to be executed by processor 202.

In alternate embodiments, secondary memory 210 may include other means for allowing computer programs or other program instructions to be loaded into computer system 200. Such means may include, for example, a removable storage unit 222 and an interface 220. An example of such means may include a removable memory chip (e.g., EPROM, RAM, ROM, DRAM, EEPROM, flash memory devices, or other volatile or non-volatile memory devices) and associated socket, or other removable storage units 222 and interfaces 220, which allow instructions and data to be transferred from the removable storage unit 222 to computer system 200.

Computer system 200 may also include one or more communications interfaces, such as communications interface 224. Communications interface 224 allows software and data to be transferred between computer system 200 and external devices. Examples of communications interface 224 may include a modem, a network interface (e.g., an Ethernet card), a communications port, a PCMCIA slot and card, etc. Software and data may be transferred via communications interface 224 in the form of signals 226, which may be electronic, electromagnetic, optical or other signals capable of being received by communications interface 224. These signals 226 are provided to communications interface 224 via a communications path (i.e., channel 228). Channel 228 carries signals 226 and may be implemented using wire, cable, fiber optics, RF link, and/or other communications channels. In a disclosed embodiment, signals 226 comprise data packets sent to processor 202. Information representing processed packets can also be sent in the form of signals 226 from processor 202 through communications path 228.

In certain embodiments in connection with FIG. 2, the terms “storage device” and “storage medium” may refer to particular devices including, but not limited to, main memory 208, secondary memory 210, a hard disk installed in hard disk drive 212, and removable storage units 218 and 222. Further, the term “computer-readable medium” may refer to devices including, but not limited to, a hard disk installed in hard disk drive 212, any combination of main memory 208 and secondary memory 210, and removable storage units 218 and 222, which respectively provide computer programs and/or sets of instructions to processor 202 of computer system 200. Such computer programs and sets of instructions can be stored within one or more computer-readable media. Additionally or alternatively, computer programs and sets of instructions may also be received via communications interface 224 and stored on the one or more computer-readable media.

Such computer programs and instructions, when executed by processor 202, enable processor 202 to perform one or more processes consistent with the disclosed embodiments. Examples of program instructions include, for example, machine code, such as code produced by a compiler, and files containing a high-level code that can be executed by processor 202 using an interpreter.

Furthermore, the computer-implemented methods described herein can be implemented on a single processor of a computer system, such as processor 202 of system 200. However, in additional embodiments, these computer-implemented methods may be implemented using one or more processors within a single computer system, and additionally or alternatively, these computer-implemented methods may be implemented on one or more processors within separate computer systems linked via a network.

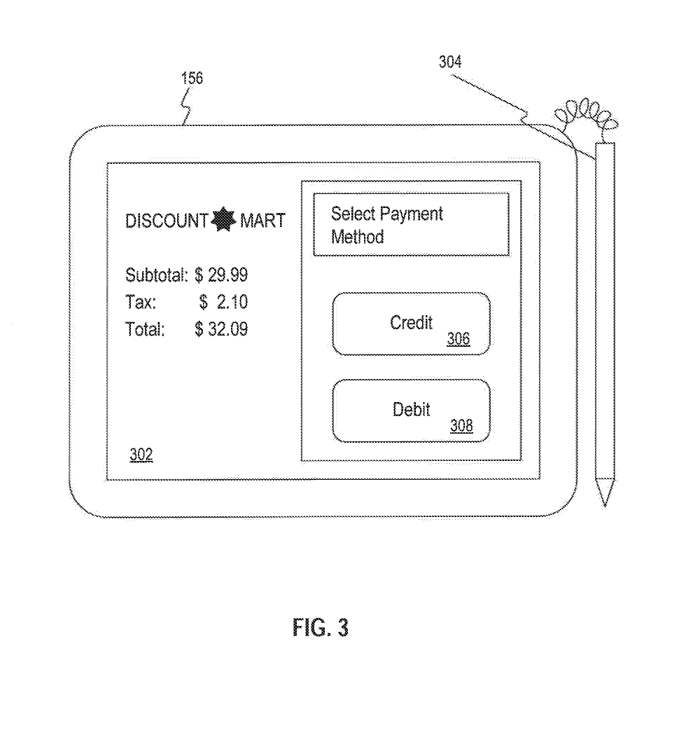

In one embodiment, a merchant may be associated with one or more point-of-sale devices configured to provide payment services and to perform known point of sale processes. FIG. 3 illustrates an exemplary point-of-sale (POS) device 156, consistent with the disclosed embodiments. As described herein, POS 156 may be implemented with a processor or computer-based system (e.g., computer-system 200 of FIG. 2), and may be configured to execute software instructions to transmit and receive data across network 120 using any of the communications protocols outlined above. For instance, POS 156 may directly communicate with network 120 through a corresponding interface, and additionally alternatively, may access communication network 120 via a server associated with the merchant (e.g., via communications link 156A to merchant server 152 of FIG. 1).

In certain embodiments, POS 156 may be disposed at a specific physical location at which a customer submits a payment to the merchant for goods and services (e.g., at a cash register at the merchant). POS terminals and devices consistent with the disclosed embodiments are, however, not limited to such exemplary configurations. In additional embodiments, POS 156 may be communicatively coupled (e.g., through a wireless or wired connection) to one or more of client devices 102, 104, and 106, to server 160, or to any additional or alternate device capable of communication across network 120. In certain embodiments, POS 156 may also facilitate mobile payment systems. For example, POS 156 may include a detachable credit card reader (e.g., a Square™) or a near field communications sensor coupled to one or more of client device 102, 104, and 106 using a wired or wireless connection.

In FIG. 3, POS 156 may include a touchscreen display 302 and a stylus 304 with which the user may interact with elements of content display on touchscreen display 302 (e.g., by establishing contact between stylus 304 and a surface of touchscreen display 302). By way of example, the user may leverage stylus 304 to select a payment mechanism for a desired transaction, e.g., by touching or swiping stylus 304 within region 306 to select a “Credit” payment option, or alternatively, by touching or swiping stylus 304 within region 308 to select a “Debit” payment option.

The disclosed embodiments are, however, not limited to such exemplary displays, and in further embodiments, POS 156 may include any additional or alternate display device, including but not limited to, a liquid crystal display (LCD) screen, and a LED display, and a CRT display appropriate to and controllable by POS 156. Further, in some embodiments, the user may interact with content displayed on touchscreen display 302 using a human finger, a physical keypad, one or more buttons, and any additional or alternate input mechanism appropriate to the displayed content and to POS 156.

Further, although not illustrated in FIG. 3, POS 156 may be communicatively coupled to one or more hardware-based devices to receive information identifying a payment instrument. Such hardware-based devices include, but are not limited to, a magnetic card reader, a RFID sensor, a biometric sensor, and a smart card reader. Further, in some embodiments, POS 156 may accept a manual input of information identifying a payment method instrument using any of the input mechanisms described herein.

The disclosed embodiments include systems and methods for identifying customized services for users and offering the customized services to the users at a point-of-sale (POS). In an embodiment, POS 156 may obtain information associated with a pending purchase transaction involving a good or service (e.g., amount of the purchase, etc.) and information associated with a payment instrument associated with the purchase transaction (e.g., an account number, expiration date, card security code, and an issuer of a credit card) from a corresponding retailer (e.g., a retailer associated with merchant system 160). In such an embodiment, POS 156 may execute software processes to transmit the purchase transaction information, the credit card information, and information identifying POS 156, across network 120 to a server (or other computing device or system) associated with a provider of POS 156 (e.g., the “POS provider”).

In certain aspects, the POS provider may correspond to a financial institution associated with financial transaction system 140, and POS 156 may transmit the purchase transaction information, the credit card information, and information identifying POS 156 to a server associated with the financial institution (e.g., transaction server 142 of FIG. 1). In one embodiment, the POS provider may also correspond to an issuer of the payment instrument associated with the purchase. In such an instance, POS 156 may provide the obtained information to transaction server 142 as a request for authorization and, additionally or alternatively, the provision of additional and customized services to the user.

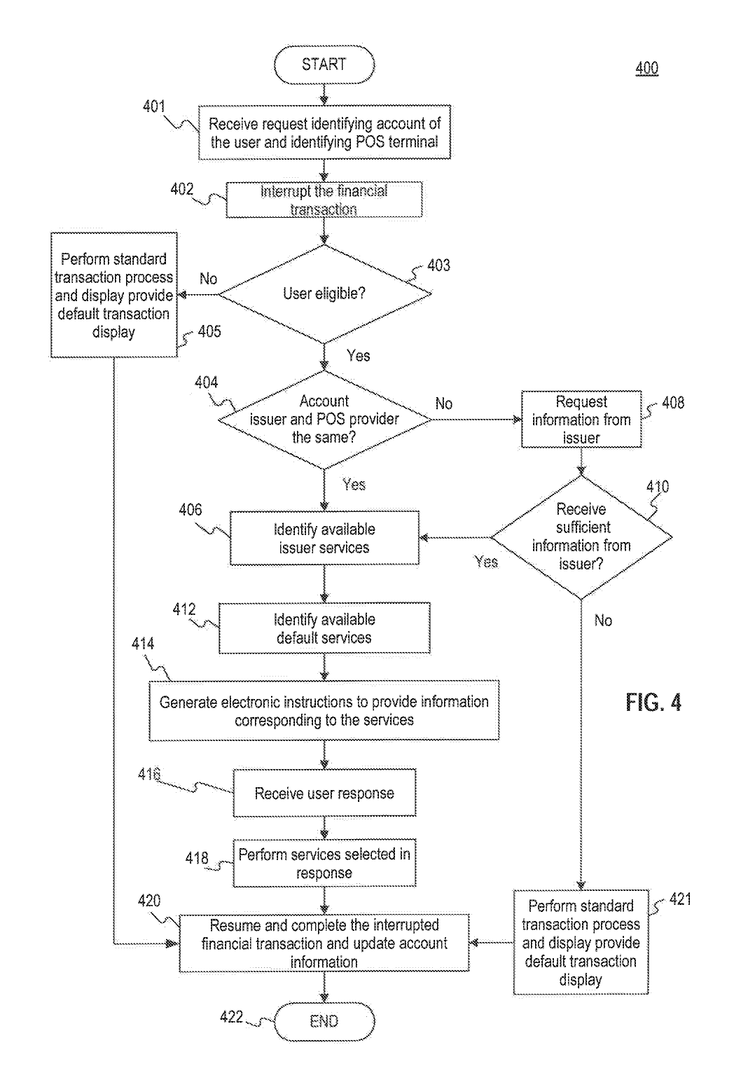

In other aspects, the POS provider may differ from the issuer of the payment instrument. In such instances, described below in reference to FIG. 4, POS 156 may provide the obtained information to transaction server 142, which may execute software instructions to identify the corresponding issuer, and transmit at least a portion of the obtained information to a server (or other computing device or system) associated with the issuer of the payment instrument as a request to obtain authorization for the purchase.

Upon authorizing the purchase, the issuer server may update an account associated with the payment instrument to reflect the authorized purchase, and to transfer funds to the retailer, either directly or through transaction server 142. In such embodiments, the issuer server, and additionally or alternatively, the transaction server 142, may retain a predetermined portion of the transferred funds as payment for processing the transaction (e.g., 5% of the total sale).

FIG. 4 illustrates an exemplary method 400 for offering customized services to a user at a point-of-sale (POS), in accordance with disclosed embodiments. In one embodiment, a server (or other computing device or system) associated with a provider of a POS terminal (e.g., transaction server 142 of FIG. 1) may be configured to obtain authorization for a purchase using a payment instrument (e.g., a credit card and/or a debit card), and to provide customized services to a user at the POS terminal (e.g., POS 156 of FIG. 3). In certain aspects, the personalized services may include, but are not limited to, one or more services provided by an issuer of the payment instrument, and one or more services offered by a retailer associated with the purchases.

In step 401, transaction server 142 may receive, from POS 156, information associated with a transaction, which includes, but is not limited to, information associated with a payment instrument (e.g., portions of a credit card account number, an expiration date, and/or a card security code (CSC)), information identifying the transaction (e.g., a purchase transaction), and information identifying POS 156. For example, as described herein, a user may purchase a number of good and/or services from a retailer, and may swipe, tap, or otherwise provide information identifying a payment instrument (e.g., a credit card) to POS 156. Further, in some instances, the user may position a mobile device (e.g., client device 102) in proximity to POS 156, and upon request by the user (or automatically upon detection of its proximity to POS 156), client device 102 may execute commands that transmit a token including the payment instrument information (e.g., a mobile wallet token) to POS 156 using a Bluetooth connection, a NFC connection, or other appropriate communications protocol. In some embodiments, POS 156 may execute software instructions to transmit information identifying the requested purchase, the credit card, and POS 156 to transaction server 142 across network 120 using one of the communications protocols outlined above.

In step 402, transaction server 142 may suspend or “interrupt” an execution of the transaction to identify and offer customized services and/or products to the user at POS 156. In one embodiment, in step 402, transaction server 142 may assign a status of “interrupted” to the transaction and store the assigned status identifier within a corresponding data record (e.g., in transaction data 144C) to reflect the interrupted state.

In certain embodiments, transaction server 142 may determine in step 403 whether the user is eligible to receive the customized services via POS 156 (e.g., whether the user opted-in to participate in the disclosed services that provided via POS 156). For example, transaction server 142 may be configured to analyze the accessed user data to determine whether the user “opted-in” to receive services provided by the issuer of the financial instrument during a transaction process involving POS 156 and the financial instrument. In other embodiments, transaction server 142 may determine whether the user's status at the financial institution renders the user ineligible to receive the POS services associated with the disclosed embodiments. For example, in step 403, if the user is eligible to receive the services associated with the disclosed embodiments (e.g., Step 403; Yes), the process of FIG. 4 proceeds to step 404. However, if the user is not eligible (e.g., does not want or is not eligible to participate), the disclosed embodiments may perform a standard transaction process for processing the transaction using the user's account (step 405). In certain embodiments, in step 405, POS 156 may be configured to perform standard transaction processes and provide a default transaction display to perform the transaction processes, in accordance with known POS transaction processes. The method may proceed to step 420.

In step 404, transaction server 142 may process the received information to identify an issuer of the payment instrument and a provider of POS 156 (i.e., a “POS provider”). Further, in step 404, transaction server 142 may determine whether the POS provider corresponds to the issuer of the user's payment instrument. In some embodiments, transaction server 142 may access and analyze information stored in one or more data storages (e.g., within customer data 144A, data repository 154, server 160, and/or data repository 170 in FIG. 1) that enable it to determine whether the POS provider corresponds to the issuer.

If transaction server 142 determines that the account issuer and the POS provider are the same entity (e.g., step 404; Yes), transaction server 142 may identify one or more first services available to the user in step 406. In an embodiment, the first services may represent “issuer” services provided to the user when the POS provider corresponds to the issuer of the user's payment instrument. In some embodiments, transaction server 142 may identify one or more of the issuer services based on stored data associated with the user (e.g., within customer data 144A of FIG. 1).

In one embodiment, transaction server 142 may identify one or more of the issuer services based on an address of the user (e.g., users located on a certain street or within a certain ZIP code) or based on employment information of the user (e.g., users who work in medical offices). In other embodiments, transaction server 142 may identify one or more of the issuer services based on stored account data (e.g., within account data 144B of FIG. 1). For example, different ones of the first services may be identified for users with a certain types or tiers of account at the financial institution (e.g. premium account, starter account, shared account, or business account). Further, in additional embodiments, transaction server 142 may identify the one or more the issuer services based on information identifying a responsiveness of the user to one or more previously provided issuer services, and information identifying a lack of responsiveness to one or more of the previously provided issuer services (e.g., as stored within data repository 170).

In additional embodiments, transaction server 142 may identify one or more of the issuer services based on stored transaction data (e.g., within transaction data 144C of FIG. 1). For example, transaction server 142 may identify one or more issuer services that could reward a customer that uses a particular account on a frequent basis or for large purchases. Alternatively, transaction server 142 may identify one or more issuer services that, upon performance, could encourage an infrequent customer to more fully utilize an account and more fully engage with a corresponding financial institution.

If, however, transaction server 142 determines that the issuer does not correspond to the POS provider (e.g., step 404; No), transaction server 142 may execute software instructions to generate a request for information identifying one or more issuer services made available to the user by the issuer in step 408. Transaction server 142 may then transmit the generated request across network 120 to a server (or other computing device or system) associated with the issuer using any one of the communications protocols described above.

In an embodiment, the issuer server may receive the transmitted request, and execute software instructions to determine whether it supports account sharing with transaction server 142. If the issuer server supports account sharing, the issuer server may access and analyze data storage to identify one or more issuer services available to the user. The issuer server may generate a response that includes information identifying the one or more issuer services, which may be transmitted to transaction server 142 across network 120 using any of the communications protocols outlined above. In some embodiments, the issuer server and transaction server 142 may be part of the same system (distributed or non-distributed) or associated with the same entity (e.g., financial institution associated with financial system 140).

In step 410, transaction server 142 may determine whether it received sufficient information from the issuer server. If so (e.g., step 410; Yes), the process of FIG. 4 continues to step 406. If not (e.g., step 410; No), transaction server 142 may determine whether the user should be prompted to present other account information (e.g., step 411), such as information from a second account (e.g., swipe a different credit card, etc.). If so (e.g., step 411; Yes), transaction server 142 may provide instructions to the POS 156 to generate a request to prompt the user to provide additional account information, such as swiping a second card or presenting second account information to POS 156 (e.g., step 413). POS 156 may receive the addition account information and provide that information such that transaction server 142 may receive it for processing to determine whether sufficient information is provided from a corresponding issuer server. (e.g., step 408).

For example, the user may have swiped a first card issued by a particular financial institution (e.g., a debit card) at POS 156. Due to a status of the debit card (e.g., a relatively low average monthly balance), and/or a status of the user at the financial institution, the issuer may provide no issuer services to the user. The issuer may, however, identify one or more accounts associated with the user, and may provide this information in its response to transaction server 142 (e.g., in step 411). In some embodiments, transaction server 142 may provide instructions to the POS 156 in step 413 to generate a request to prompt the user to swipe a second card of the issuer. For example, the second card may be associated with a rewards program provided by the issuer, or additionally or alternatively, the second card may be associated with a higher-tier account than that associated with the debit card (e.g., a “Gold” card). In certain embodiments, by swiping the second card, transaction server 142 may receive sufficient information from the issuer regarding issuer rewards available to the user (e.g., step 410). The disclosed embodiments are, however, not limited to first and second cards associated with the same issuer, and in additional embodiments, transaction server 142 may access account data associated with the user (e.g., account data 144B of FIG. 1) to determine whether the user should be prompted to supply additional account information in step 413.

However, if transaction server 142 determines that the user should not be prompted to present other account information, and/or that the issuer services cannot or should not be provided to the user via POS 156 (e.g., step 411; No), it may communicate information to POS 156 such that the standard transaction process and displays are provided in accordance with the processes disclosed above in connection with step 405 (e.g., step 421).

In one embodiment, transaction server 142 may receive the response from the issuer server and determine, in step 410, whether the response identifies at least one issuer service. If transaction server 142 determines that the response includes the at least one issuer service (e.g., step 410; Yes), then exemplary method 400 may proceed to step 406. Transaction server 142 may, in step 406, execute software instructions to parse the received response to identify the at least one issuer service.

In some embodiments, in step 406, transaction server 142 may assign rankings to the identified issuer services. For example, transaction server 142 may assign ranks to the issuer services based on corresponding priorities or importances (e.g., the financial institution may establish rules specifying that services related to account security may be ranked at a higher priority than services related to advertisements or discounts). In other instances, transaction server 142 may assign ranks to the available services based on the user's history of accepting or declining available services (e.g., as stored in cloud-based data repository 170). For example, transaction server 142 may decrease a rank assigned to an available service related to account security when the user has not accepted previously presented security-based services within a predetermined time period, e.g., thirty days. In other instances, transaction server 142 may increase a rank assigned to an available service related to loyalty programs when transaction server 142 determines that the user accepted greater than a threshold number of loyalty-based services within the predetermined time period.

Transaction server 142 may, in some embodiments, identify some or all of the ranked issuer services for presentation at POS 156 in step 406. For instance, transaction server 142 may select a threshold number of the highest-rated issuer services for presentation to the user at POS 156. The threshold number could represent a predetermined, fixed value, or alternatively, the number of ranked issuer services could be adjustable by the user, a retailer associated with POS 156, or by the POS provider.

For example, transaction server 142 may dynamically control and/or adapt the number of selected issuer services based on network conditions and/or physical conditions at the retailer. In some aspects, transaction server 142 may monitor conditions of communications network 120, and may adaptively determine a number of first services selected for presentation at POS 156 based on the network conditions. For example, when a monitored bandwidth of the network falls below a predetermined lower threshold value, transaction server 142 may reduce (e.g., by 50%) the number of first services selected for presentation at POS 156. In other instances, when the monitored bandwidth of the network rises above a predetermined upper threshold value, transaction server 142 may increase (e.g., by 50%) the number of first services selected for presentation at POS 156. Further, in some aspects, transaction server 142 may select specific types of services based on the monitored network bandwidth. For instance, when the monitored network bandwidth falls below the predetermined lower threshold value, transaction server 142 may remove from presentation by POS 156 one or more services requiring multiple bandwidth-consuming authentication steps (e.g., as indicated by information stored within data repository 144 or 170, or as monitored by transaction server 142 during operation).

In certain aspects, transaction server 142 may obtain, from a server associated with the retailer (e.g., merchant server 152 of FIG. 1), information identifying an average wait time at the retailer's checkout stations, and may adaptively modify the number of first services selected for presentation at POS 156 to reduce the average wait time. For example, during periods when wait times are short, transaction server 142 may select a larger number of first services for display at POS 156 than during periods when wait times are long. Additionally or alternatively, transaction server 142 may modify the number of selected issuer services in response to a request from an employee of the retailer (e.g., a manager) received from merchant server 152.

Further, in an embodiment, transaction server 142 may establish the number of selected issuer services based on one or more preferences of the user. For example, transaction server 142 may be configured to access and analyze data storage (e.g., customer data 144A of FIG. 1), to determine whether the user “opts-out” of programs that provide customized services. If transaction server 142 determines that the user opts-out of such programs, transaction server 142 may authorize the purchase based on the identified account information without providing information identifying services to POS 156 (e.g., steps 403, 405, 416).

In additional embodiments, the user preferences may include limits and/or caps on the number of issuer services provided to the user on a particular day, and additionally or alternatively, a maximum number of transactions for which transaction server 142 may provide customized services (e.g., a “velocity” at which customized services are provided to the user). For instance, transaction server 142 may determine that a user desires to receive information identifying at most five services per transaction, and further, that the user desires to receive information identifying available services for only the first ten transactions during a given day. In certain embodiments, transaction server 142 may identify no more than the identified maximum number of issuer services for the user in step 406, and additionally or alternatively, cease the identification of issuer services in step 406 once the maximum number of daily transactions has been met or exceeded.

Furthermore, the user preferences may also specify limits on types of issuer services selected by transaction server 142 in step 406. For example, transaction server 142 may identify that the user elects not to receive information identifying opportunities to create new credit card accounts. In certain embodiments, transaction server 142 may filter the selected first services to remove one or more of the first services that conflict with the user's preferences.

In certain embodiments, transaction server 142 may be unable to identify any issuer services in step 406, or alternatively, transaction server 142 may identify fewer than the threshold number of issuer services. In such an instance, transaction server 142 may execute software instructions to access and analyze stored data (e.g., customer data 144A and/or account data 144B in FIG. 1) to identify one or more second services. In one embodiment, the second services represent “default” services available to all users, regardless of whether or not the POS provider issued a corresponding payment instrument.

Referring back to FIG. 4, in step 412, transaction server 142 identifies one or more default services, which include, but are not limited to, basic banking functions (e.g., balance inquiries, etc.), an offer to purchase a prepaid cellular minutes, an offer to purchase an extended warranty on a purchased product, or a request to join the retailer's mailing list. In an embodiment, transaction server 142 may identify the one or more of the default services based on information identifying a responsiveness of the user to one or more previously provided default services, and information identifying a lack of responsiveness to one or more of the previously provided default services. Further, a number of the default services identified in step 412 may vary based on a number of the issuer services identified in step 406. For example, transaction server 142 identifies a number of issuer services equivalent to the user-specified maximum number of services in step 406, In such an instance, transaction server may not identify any default offers in step 412.

In step 414, transaction server 142 may generate a message including information identifying the issuer and/or default services (e.g., as identified by transaction server 142 in steps 406 and 408), and including information identifying an outcome of the authorization of the transaction. Transaction server 142 may then execute software processes to transmit the generated message across network 120 to POS 156 using any of the communications protocols outlined above.

In one embodiment, transaction server 142 may provide to POS 156 a subset of information that may be used by POS 156 to display selected information. Additionally or alternatively, transaction server 142 may be configured to generate and provide only enough information to indicate to POS 156 which interface elements to display, or alternatively may generate entire customized interface images that are transmitted in a form ready to be displayed on POS 156.

In an embodiment, POS 156 may receive the message from transaction server 142, and may execute software instructions to render the received information for display to the user (e.g., on touchscreen display 302 of FIG. 3). Further, in some embodiments, POS 156 may execute software instructions to store information identifying additional or alternate services that may be provided to the user. For example, upon receipt of the message from transaction server 142, POS 156 may select one or more of these services for presentation to the user.

For example, as described above, the user may review the outcome of the authorization on touchscreen display 302, and may further provide an acceptance of the authorized transaction by touching a portion of touchscreen display 302 with a stylus or finger, or alternatively, by entering a signature on touchscreen display 302 using the stylus of finger. Additionally, the user may review information identifying one or more of the services identified by transaction server 142, and additionally or alternatively, by POS 156, and may further select at least one of the services, e.g., using a stylus, finger, or other mode of input. Upon receiving the acceptance of the authorized transaction and the selection of one or more of the available services, POS 156 may generate a response that includes information associated with the acceptance and identifying the user's selected service or services, which may be transmitted across network 120 to transaction server 142.

Referring back to FIG. 4, transaction server 142 may receive the response from POS 156 in step 416. As described herein, the received response may include information indicating the user's acceptance of the authorized transaction (e.g., an image of a signature) and information identifying one or more services selected by the user.

In step 418, transaction server 142 may execute software instructions to facilitate a performance of one or more of the services selected by the user. In an embodiment, the user-selected services include at least one user-selected issuer service, and when the POS provider corresponds to the issuer, transaction server 142 may be configured to access and obtain data necessary to perform the at least one user-selected issuer service. Alternatively, when the POS provider does not correspond to the issuer, transaction server 142 may generate and transmit a request to the issuer server to perform the at least one user-selected issuer service. In some embodiments, transaction server 142 may execute software processes to obtain data indicative of an outcome of and a completion of the at least one user-selected issuer service, which may be transmitted to POS 156 over network 120 using any of the communications protocols disclosed herein.

In additional embodiments, the user-selected services include at least one user-selected default service. In step 418, transaction server 142 may access and obtain information necessary to perform the at least one user-selected default service, and information one or more entities (e.g., associated with server 160 of FIG. 1) capable of performing the at least one user-selected default service. Transaction server 142 may, in step 418, generate and transmit a request, to the one or more entities, for a performance of at least one user-selected default service. For example, in some embodiments, transaction server 142 may execute software processes to obtain data indicative of an outcome of and a completion of the at least one user-selected default service, which may be transmitted to POS 156 over network 120 using any of the communications protocols disclosed herein.

In step 420, transaction server 142 may execute software instructions to update account information associated with the user, to resume the interrupted transaction, and to complete the authorized purchase. By way of example, when the POS provider corresponds to the issuer, transaction server 142 may be configured access account data for the user in a corresponding repository (e.g., account data 144B of FIG. 1), and may update the accessed account data to reflect the authorized purchase and authorize a transfer of funds to the retailer to complete the transaction. Alternatively, if the POS provider fails to correspond to the issuer, transaction server 142 may generate and transmit a request to the issuer computer system to resume the interrupted transaction, complete the authorized purchase, update corresponding portions of the user's account data, and authorize the necessary transfers of funds. Exemplary method 400 may complete in step 422.

In certain embodiments, transaction server 142 may complete a financial transaction in step 420 using one or more of the user-specified services fulfilled in step 418, and additionally or alternatively, a new or modified product resulting from an outcome of the one or more user-specified services fulfilled in step 418. For example, transaction server 142 may increase a credit limit associated with a payment instrument of the user (e.g., a credit card) in step 418, and transaction server 142 may complete a purchase in step 420 in accordance with the increased credit limit. Further, for example, transaction server 142 may establish a retailer credit card for the user in step 418, and transaction server 142 may complete a purchase from the retailer in step 420 using the newly established retailer credit card.

In an additional embodiment (not depicted in FIG. 4), transaction server 142 may determine that the received response identifies no issuer services (e.g., step 422; No), transaction server 142 may execute software instructions to identify one or more default services for the user in step 412, as described herein. In such an embodiment, transaction server 142 may provide, to POS 156, one or more default services for presentation to the user in the absence of issuer services identifiable by the issuer computer system.

In the embodiments described above, transaction server 142 executes software processes to identify one or more services available to the user. For example, such services include, but are not limited to, services related to one or more accounts held at a financial institution associated with transaction server 142 and services related to merchants associated with POS 156 (e.g., requests to establish store credit cards). In certain instances, the services related to accounts at the financial institution may include, but are not limited to, alerts of potential fraudulent activity, offers of overdraft protection, account management services (e.g., funds transfers, deposits, withdrawals, etc.), user name and password management services, card management services (e.g., requests for new cards), credit omit inquiries and alerts, secure messaging services, and appointment reminders.

Services consistent with the disclosed embodiments may also enable a user to complete an other-channel transaction at POS 156 (e.g., enabling the user to provide, as input to POS 156, a PIN that authenticates an online application for a financial services account). Further, in some aspects, and upon initiation of a purchase transaction, the user may swipe, tap, or otherwise provide information identifying a payment instrument (e.g., a credit card) to POS 156, which may transmit the provided payment instrument information to transaction server 142. In response, transaction server 142 may identify additional or alternate payment instrument and/or financial service accounts suitable for the initiated payment transaction, and may provide information identifying the additional or alternate payment instrument and/or financial service accounts to POS 156 for presentation and selection by the user.

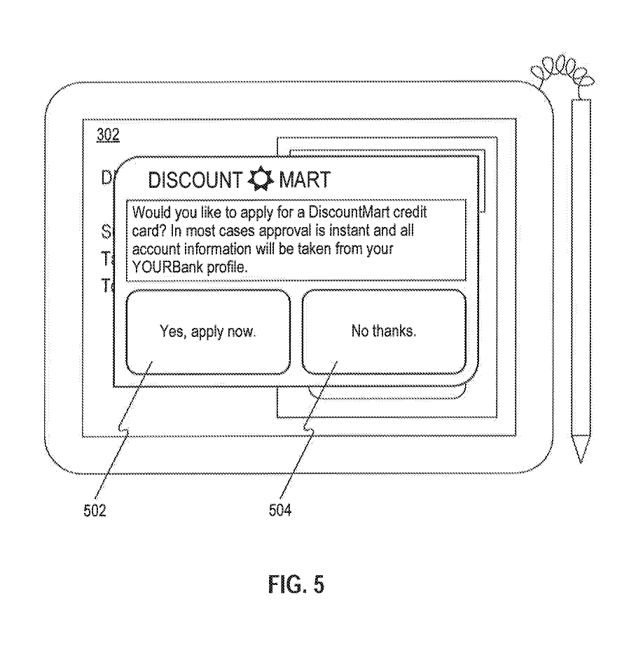

In such embodiments, POS 156 may receive and render for display information associated with the issuer services to the user, as described below in reference to FIG. 5-13. However, the disclosed embodiments are not limited to such issuer services, and in further embodiments, transaction server 142, may identify any additional or alternate account and/or merchant services appropriate to financial system 140, POS 156, and the user. Further, in additional embodiments, the issuer may partner with a retailer or merchant (e.g., a retailer or merchant associated with merchant server 160) to offer goods and services for sale through POS 156.

For example, as illustrated in FIG. 5, POS 156 may execute software instructions to provide an opportunity for the user to apply for a retailer-specific or “store” credit card. In some embodiments, if the user selects region 502 within display 302, transaction server 142 may transmit, to a server associated with a corresponding retailer or issuer of the retailer card (e.g., within customer data 144A of FIG. 1), user data necessary to complete a corresponding application for credit.

For example, the retailer may be associated with a corresponding server (e.g., merchant server 152 of FIG. 1), and merchant server 152 may coordinate with transaction server 142 to access the corresponding data repository and obtain the necessary user data. In such an embodiment, merchant server 152 may analyze the obtain user data in real time (e.g., in view of retailer-specific rules on income, debt, etc.) in real time to provide a near instant decision.

Alternatively, upon receiving the necessary user data, merchant server 152 may poll various credit reporting agencies (e.g., as associated with server 160 in FIG. 1) to obtain a credit report for the user. In certain embodiments, portions of the user data and the received credit report may be analyzed by merchant server 152, which may provide an approval decision to transaction server 142 within seconds. For instance, the received credit report may include a credit score for the user, and rules established by the merchant (and additionally or alternatively, by the financial institution) may specify a minimum credit score (e.g., an absolute score or a score dynamically determined in conjunction with portions of the user data) enabling merchant server 152 to approve the application. Transaction server 142 may provide information associated with the approval to POS 156, which may execute software processes to render and display the received information. In certain aspects, the collection of data from data repositories and third party entities (such as a credit bureau, e.g., TransUnion™, Experian™, and Equifax™) may be performed automatically by transaction server 142 and/or merchant server 152, and may be invisible to the user and to one or more employees of the retailer or merchant.

In other embodiments, POS 156 may execute software instructions to provide an opportunity for the user to complete an outstanding or pending other-channel transaction. For instance, the user may access a digital portal associated with financial system 140 and/or merchant system 140, and may complete portions of a digital application for credit at the financial institution and/or the merchant. The user may, however, postpone a final authentication that would complete the application (e.g., an entry of PIN into the digital portal) and enable financial system 140 and/or merchant system 140 to process the digital application. As described above, data repository 170 may include data records linking the user with the outstanding and incomplete digital applications, which transaction server 142 may identify and access based on the provided payment instrument information associated with the user (e.g., in step 401). In certain aspects, transaction server 142 may transmit information identifying the outstanding digital credit application and one or more steps required to complete the outstanding digital credit application to POS 156 for presentation to user.

In some aspects, POS 156 may present at least a portion of the information identifying the outstanding digital credit application to the user, along with instructions for completing the outstanding digital credit application. For instance, POS 156 may present information requesting that the user enter a PIN or other alphanumeric identifier into POS 156 (e.g., using a keypad or touchpad) to complete the outstanding digital credit application and forward the completed applciation to financial system 140 and/or merchant system 140 for processing. Additionally or alternatively, POS 156 may enable a user to provide input requesting a deletion of the stored application, and additionally or alternatively, input requesting postponement of the completion process.

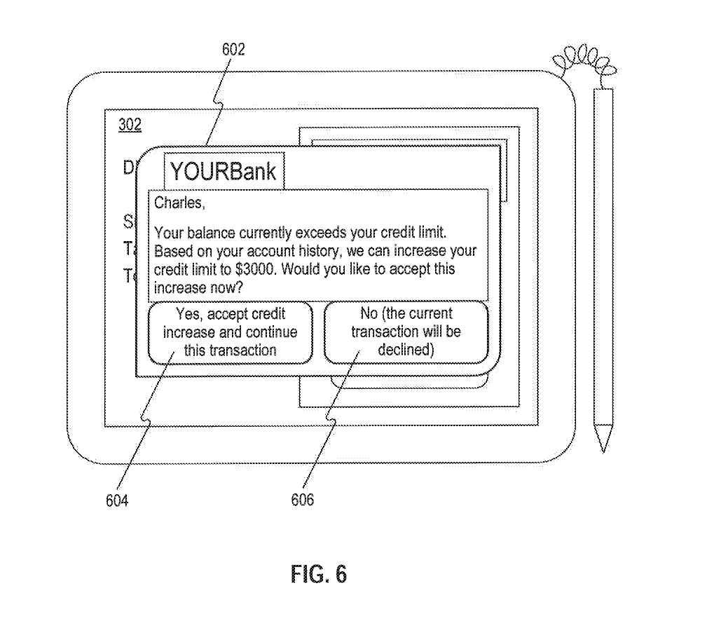

In additional disclosed embodiments, the user may attempt to purchase a good or service with a credit card, and transaction server 142 may access and obtain stored account data for the user (e.g., account data 144 of FIG. 1), which indicates that an account balance for the credit card exceeds a corresponding credit limit. In certain aspects, the issuer of the account (e.g., transaction server 142 of FIG. 1) might decline the transaction. Alternatively, transaction server 142 may identify a service that provides the user with option to raise the corresponding credit limit at POS 156, and transmit information associated with the identified service to POS 156, as described below in FIG. 6.

In FIG. 6, POS 156 receives the transmitted information and renders the transmitted information for display within display 302 of POS 156. For example, POS 156 displays a dialog box 602 within display 302 that notifies the user that the balance of the selected account is over the credit limit, and proposes a preapproved increase in the credit limit that would facilitate the purchase. In one embodiment, the preapproved credit limit increase may be determined by transaction server 142 and/or an issuer of the credit card. In additional embodiments, POS 156 may provide the user with an opportunity to input a desired new credit limit, which POS 156 may transmit to transaction server 142 for approval. In some embodiments, the amount requested by the user may be approved nearly instantly, allowing the user to complete the transaction with minimal delay.

In certain aspects, if the user chooses to accept the credit limit increase (e.g., by selecting interface element 604 within display 302), the transaction may be completed. The user may also be given the option not to raise the credit limit, for example by selecting interface element 606 within display 302, in which case the transaction may be declined.

In further embodiments, POS 156 may provide users with an opportunity to select additional banking services offered by a corresponding financial institution or issuer of a payment instrument. Such additional services may include, but are not limited to, obtaining an account statement, requesting electronic funds transfers between accounts, obtaining information identifying recent transactions associated with the user account, obtaining balance information identifying available funds associated with the account, and/or opening or activating a new account with the financial institution associated with transaction server 142. Further, in some instances, POS 156, in conjunction with merchant server 152, may provide banking services that enable the user to deposit funds into an account at the financial institution (e.g., cash and/or check) and/or withdraw funds from an account at the financial institution. In other instances, financial institution system 140 and/or merchant system 150 may collect a fee from the user for the deposit or withdrawal transactions. Alternative, financial institution system 140 and/or merchant system 150 may waive the fee based on the user's status at the financial institution or merchant, a purchase by the user from the merchant, and/or the user's participation in a loyalty or rewards program.

POS 156 may also provide users with an opportunity to manage authentication credentials required to access digital portals and automated teller machines (ATMs) associated with the financial institution and transaction server 142. For example, POS 156 may present, to a user, an opportunity to modify a user name and/or password required to access the digital portal of the financial institution or to select a new PIN required to access ATMs and POSs associated with the financial institution. In some aspects, POS 156 may receive input from the user requesting the change, may require the user to input (e.g., via keypad or touchpad) one or more existing authentication credentials, and may receive, from the user, the new or modified authentication credentials, which POS 156 may transmit to transaction server 142 for processing and storage.

In other aspects, POS 156 may provide users with an opportunity to request a new credit card, debit card, or loyalty or rewards card issued by the financial institution or merchant. For example, the user's credit card may be damaged or may be unreadable, and POS 156 may provide the user with an opportunity to request that the financial institution issue a replacement credit card. POS 156 may present information identifying the opportunity to the user, and upon authentication of the user and receipt of the user's input (e.g., via keypad, touchpad, etc.), POS 156 may transmit the user's input to transaction server 142 as a request to obtain the replacement credit card. Transaction server 142 may, in some instances, process and approved the received request, and issue the user a replacement credit card, which the financial institution may mail to the user's current address (e.g., as stored within customer data 144A).

In further embodiments, POS 156 may provide users with an opportunity to select additional banking services offered by a corresponding financial institution or issuer of a payment instrument. Such additional services may include, but are not limited to, obtaining an account statement, obtaining information identifying recent transactions associated with the user account, obtaining balance information identifying available funds associated with the account, and/or opening or activating a new account with the financial institution associated with transaction server 142.

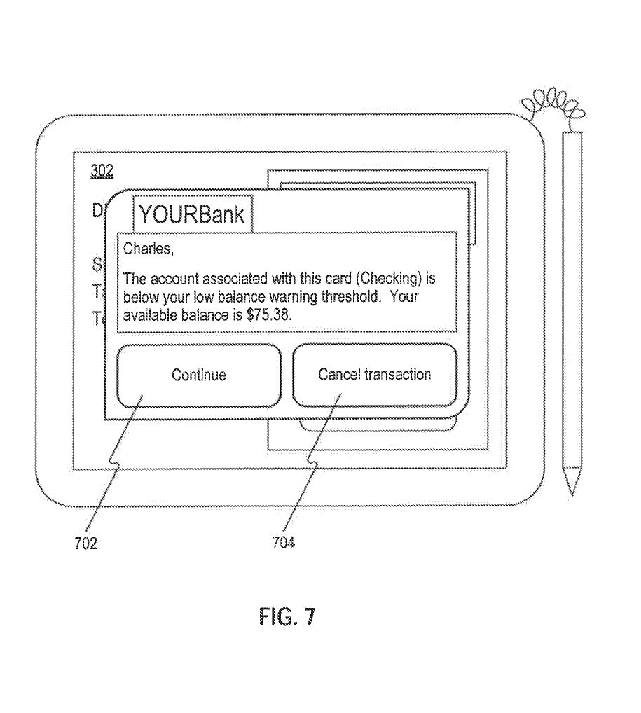

Further, in an embodiment, transaction server 142 may generate an alert when the user attempts to complete a transaction using an account having a remaining balance that falls below a threshold limit. The threshold limit may, in an embodiment, be specified by the user or established by one or more policies of the issuer. For example, as depicted in FIG. 7, POS 156 may display the alert and provide the user with an option to continue with the transaction (e.g., by selecting region 702 within display 302) or to cancel the transaction (e.g., by selecting region 704 within display 302). Further, in additional embodiments, POS 156 may display alerts regarding other account conditions, which include, but are not limited to, an expiration of the user account, a recent deposit of funds (e.g. a paycheck), or upcoming changes in the account.

In additional embodiments, transaction server 142 may generate an alert when the user attempts to complete a transaction using an account that is currently overdrawn (e.g., having a negative balance) or that is at risk of becoming overdrawn based on the transaction and/or a history of prior overdrafts. In other aspects, and upon receipt of the user's payment instrument information from POS 156, transaction server 142 may access the user's stored account data (e.g., account data 144B of FIG. 1) and determine whether one or more of the user's account (or accounts) is currently or is in danger of becoming overdrawn, e.g., based on a current balance or a history of negative balances.

Transaction server 142 may, for example, identify a service that provides the user with option to obtain overdraft protection for one or more of the user's financial accounts, and transmit information associated with the overdraft protection service to POS 156. In some aspects, transaction server 142 may pre-approve the user for the overdraft protection service based on, among other things, a number, type, and aggregate value of the financial services accounts held by the user, a history of overdrafts by the user, and any additional or alternate criteria appropriate to the user's accounts and the financial institution. Further, depending on these criteria, transaction server 142 may assess a fee for the pre-approved overdraft protection service, or may offer the overdraft protection service to the user on a complimentary basis.

POS 156 may, for example, receive the transmitted information and render the transmitted information for display within display 302. For example, POS 156 may present information notifying the user that one of the more of the user's financial services accounts are currently overdrawn, or at a risk of becoming overdrawn, based on the initiated transaction, and may propose that the user accept a pre-approved overdraft protection service for the financial services accounts. The user may provide input to POS 156 accepting or declining the offered overdraft protection service (e.g., using a keypad or touchpad), and POS 156 may transmit the user's input to transaction server 142 for processing (e.g., an enrollment of the user into the overdraft protection service).

Additionally, transaction server 142 may access information identifying one or more of the user's upcoming appointments with representatives of the financial institution (and additionally or alternatively, related entities), and may generate an alert of an upcoming appointment for presentation to the user on POS 156. For example, the upcoming appointment may include, but is not limited to, an appointment with an investment advisor of the financial institution or a loan officer of the financial institution. Transaction server 142 may transmit the generated alert to POS 156, which may render the received alert for presentation within display 302. The user may, for example, provide input to POS 156 (e.g., via a touchpad or keypad) that confirms the upcoming appointment, requests cancellation of the upcoming appointment, and additionally or alternatively, proposes a new time and/or date for the appointment. POS 156 may transmit the received input to transaction server 142, which may update accordingly the time and/or date of the upcoming appointment and store information associated with the upcoming appointment (e.g., in data repository 144).

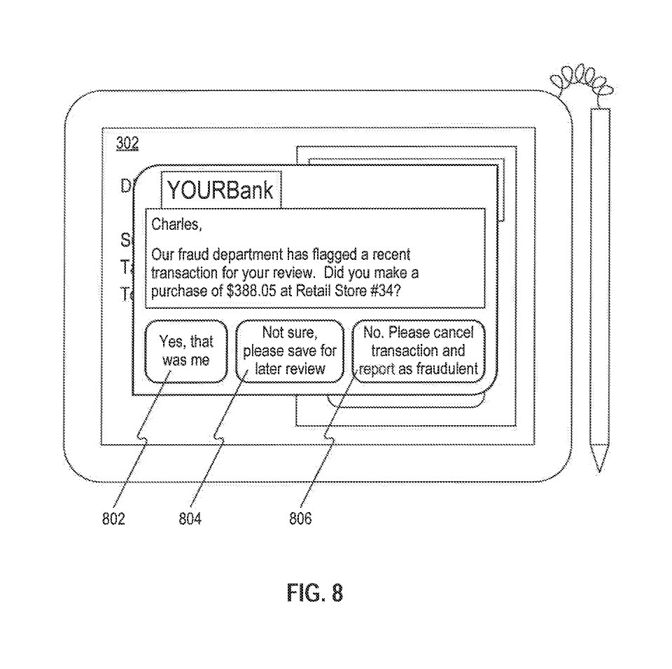

Furthermore, transaction server 142 may identify a recent transaction that does not conform to the user's normal account activity (e.g., as stored in account data 144B or transaction data 144C of FIG. 1), and may transmit information identifying the non-conforming transaction to POS 156. For example, as depicted in FIG. 8, POS 156 may display an alert to the user indicating that a charge of $388.05 has been recorded from merchant Retail Store #34, and that transaction does not conform to the user's normal habits. In certain embodiments, the alert displayed by POS 156 requests the user's confirmation of the authenticity of the non-conforming transaction.

For example, if the user did not authorize the non-conforming transaction, the user may select region 806 within display 302 to identify the non-conforming transaction as fraudulent, and to report the fraudulent transaction to transaction server 142. Alternatively, the user may select region 804 within display 302 to flag the transaction for later review. In response to the selection of region 804, transaction server 142 may generate a subsequent alert for display on POS 156 (or another POS terminal) at a later time, or alternatively, the user may access a web page of the account issuer using a client device (e.g., client device 102) and review the account, or may contact the account issuer by telephone or email. If, however, the user recognizes the transaction, the user may select region 802 within display 302 to indicate that the non-confirming purchase was authorized and is not fraudulent.

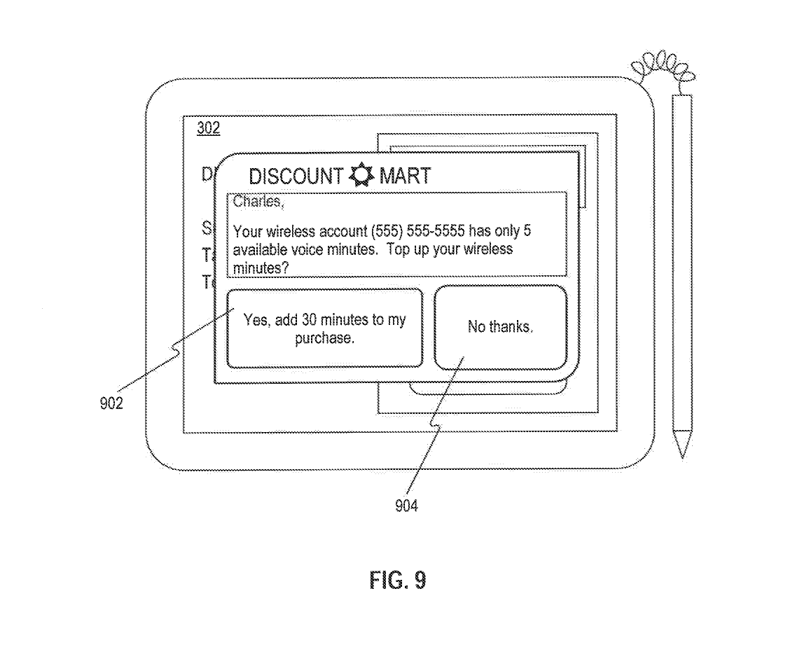

Further embodiments may provide opportunities for the issuer to partner with a retailer or merchant to offer goods and services through POS 156. For example, in FIG. 9, POS 156 may provide the user with an option to purchase prepaid wireless voice minutes in conjunction with a desired good or service. In some embodiments, transaction server 142 may obtain data indicative of a remaining number of minutes from a server associated with the user's wireless carrier (e.g., server 160 of FIG. 1), which may be stored by transaction server 142 in a corresponding data repository (e.g., customer data 144A of FIG. 1). For example, transaction server 142 may poll the wireless carrier server at regular intervals (e.g., weekly and/or monthly) to ensure that the stored wireless data accurately reflects the status of the user's account with the wireless carrier.

In an embodiment, in FIG. 9, transaction server 142 may display a message indicating that the minutes associated with the user's wireless account have fallen below a threshold level (e.g., five minutes), and providing the user with an opportunity to purchase additional minutes to “top-up” the account. For example, the user may select region 902 within display 302 to purchase the additional minutes and top-up the wireless account, and POS 156 may transmit information identifying the requested purchase to transaction server 142. Upon receipt of the information identifying the requested purchase, transaction server 142 may update the stored wireless account information and transmit information regarding the purchased minutes to the wireless carrier server. Alternatively, the user may decline the offered service by selecting region 904, and no additional minutes will be purchased.

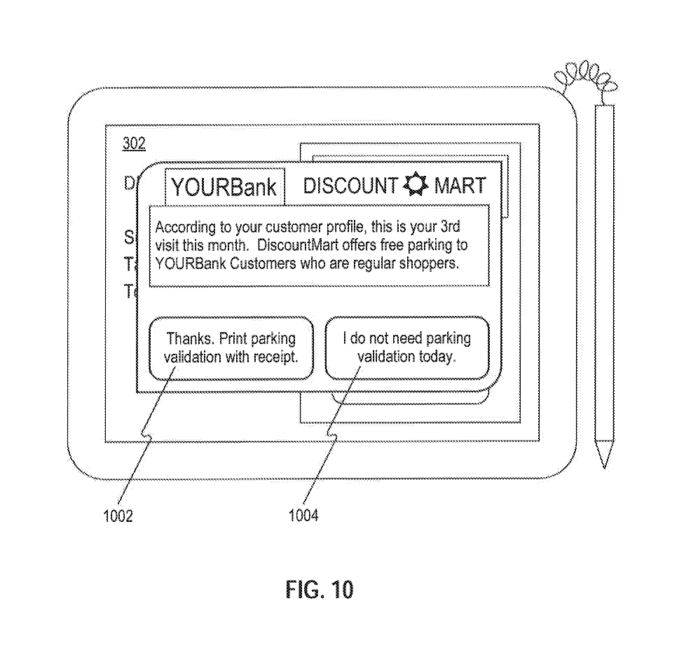

In additional embodiments, transaction server 142 may access stored transaction data associated with the user (e.g., transaction data 144C in FIG. 1), and may execute software instructions to determine that the user shopped at a retailer a threshold number of times during a threshold time period (e.g., three times in the same month). Transaction server 142 may then establish contact with a server associated with the retailer (e.g., merchant server 152 of FIG. 1) across network 120, and provide information alerting merchant server 152 to the user's frequent purchases. In response to the alert, merchant server 152 may provide the user with a benefit, e.g., a free parking validation for the user, and may transmit information identifying the benefit to transaction server 142 for display at POS 156, as illustrated in FIG. 10. If the user accepts the offer by selecting region 1002, a validation ticket may be printed at the POS terminal, e.g., with the user's receipt. In additional embodiments, the retailer may provide any number of additional services based on the user data at transaction server 142, including, but not limited to, such as offers, services, coupons, and discounts.

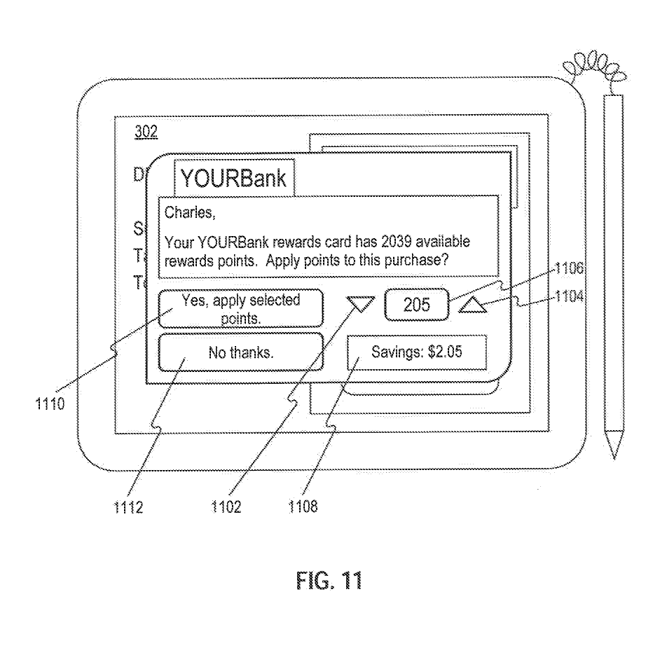

FIGS. 11-13 illustrate exemplary services enabling a user to manage rewards programs at POS 156, in accordance disclosed embodiments. For example, in FIG. 11, a user with a rewards credit card associated with a corresponding issuer (e.g., the financial institution associated with transaction server 142) may manage reward points using POS 156. In some embodiments, transaction server 142 may obtain (e.g., from customer data 144A of FIG. 1) information identifying a rewards program and a number of available rewards points, and may execute software instructions to transmit the obtained information to POS 156 for presentation to the user, as illustrated in FIG. 11.

For example, in FIG. 11, the user may select and modify a number of points to apply to the current transaction using regions 1102 and 1104 within display 302. POS 156 may display a savings amount 1108 within display 302, which indicates the savings (in dollars) that will be applied as a result of the selected number of points. The user may select region 1110 within display 302 to confirm the application of the rewards points, or select region 1112 within display 302 to decline to apply points.

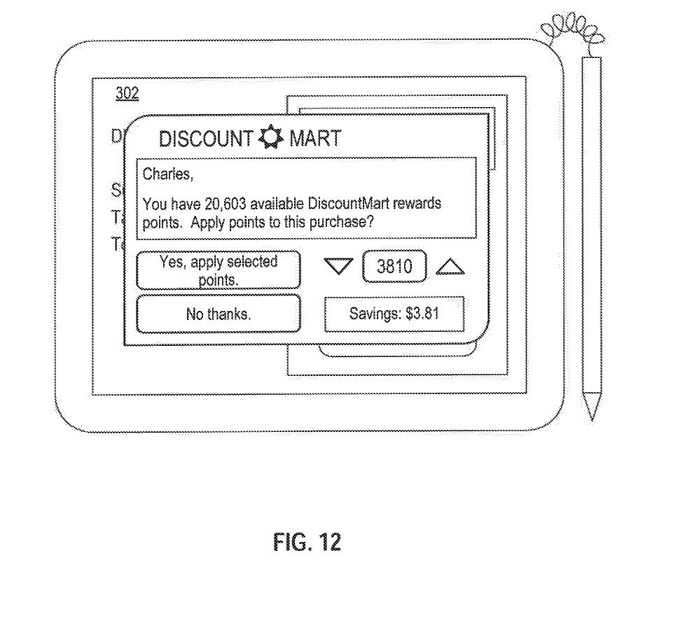

Similarly, in FIG. 12, POS 156 may allow a user with a rewards account issued by a retailer to manage reward points. In such an embodiment, the user may be able to set a number of points to apply to the current transaction in a manner similar to that described above in reference to FIG. 11.

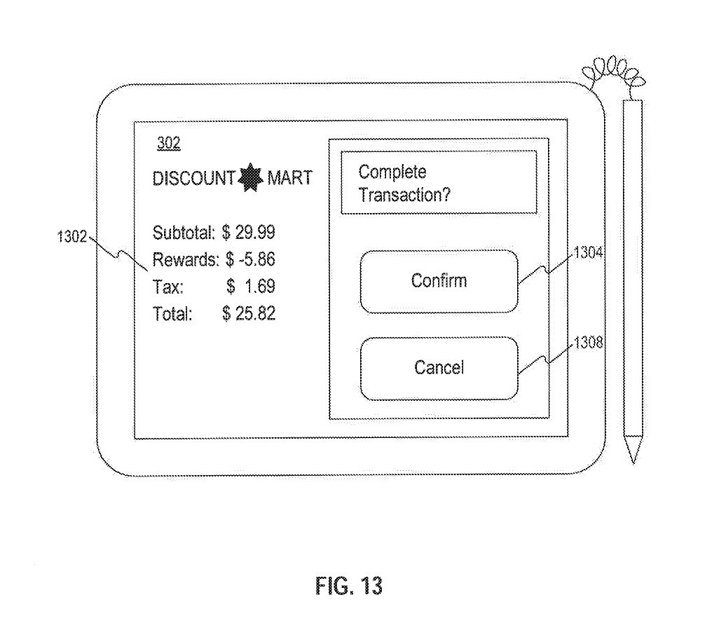

Further, in the embodiment of FIG. 13, POS 156 may facilitate the user's management of rewards programs offered by both a retailer and an account issuer. For example, in region 1302 of FIG. 13, POS 156 displays the combined total savings applied from rewards points programs shown in FIGS. 11 and 12, along with taxes and the total charge for the transaction. The user may then be provided with an opportunity to select region 1304 to approve the transaction or select region 1308 and cancel the transaction.

In the embodiments described above, transaction server 142 may be configured to provide information identifying user-customized services to POS 156 for presentation to the user. In some aspects, and in addition to payment instrument information provided to POS 156, the user may also input one or more authentication credentials (e.g., a PIN) into POS 156 with information requesting performance of the user-customized service, offer, and/or reward. POS 156 may transmit the inputted authentication credential and request to transaction server 142, which, in some instances, may perform the requested services. In other instances, however, transaction server 142 may require additional authentication credentials or verification information prior to preforming the requested services.

In one aspect, transaction server 142 may generate and transmit to POS 156 an alert requesting that the user telephone a call center associated with the financial institution to provide the additional authentication credentials and/or to verify the user's intention that transaction server 142 perform the requested service. In other aspects, transaction server 142 may transmit an out-of-band alert to a device of the user (e.g., client device 102) request that the user contact the call center or respond electronically with the required additional authentication credential or verification. Out-of-band alerts consistent with the disclosed embodiments may include, but are not limited to, text messages, emails, and messages posted to or delivered within a social network of the user. Transaction server 142 may also transmit a secured message to the user within a messaging application associated with the financial institution and provided within a corresponding digital portal.

Further, in some embodiments, the user may decline a customized service identified by transaction server 142 and presented by POS 156 (e.g., within display 302). In some instances, however, the user may provide to POS 156 input identifying a continued interest in the declined service, or services similar to the declined service, and POS 156 may transmit the provided input to transaction server 142. Further, in some instances, transaction server 142 may access information identifying services previously declined and accepted by the user (e.g., within data repository 170), and may process the accessed information to identify one or more services, offers, and/or rewards, and additionally or alternatively, classes of services, offers, and/or rewards, that may be of potential interest to the user.

In certain embodiments, transaction server 142 may be configured to generate and provide to the user a message identifying one or more services, offers, and/or rewards (or types of services, offers, and/or rewards) of potential interest to the user. Transaction server 142 may, for example, provide the generated message to the user through a secure messaging application associated with a digital portal of the financial institution (or as an email or text message, using email addresses and telephone numbers specified by the user in profile data). The generated message may identify the one or more services, offers, and/or rewards (or types of services, offers, and/or rewards) of potential interest to the user, and may provide the user with a mechanism for obtaining additional information on the services, offers, and/or rewards (e.g., a link).

In the embodiments described above, transaction server 142 may be configured to identify services, offers, and/or rewards available to a user based on payment instrument information, merchant information, and/or user information received from POS 156. In some aspects, transaction server 142 may provide information identifying the available services, offers, and/or rewards to POS 156, which may present portions of the provided information to the user. In further aspects, the user may provide input to POS 156 selecting or accepting the presented services, offers, and/or rewards, and upon receipt of the input from POS 156, transaction server 142 may be configured to perform the services on behalf of the user or provide the offers and/or rewards to the user.

In additional embodiments, transaction server may be configured to identify, based on the payment instrument, merchant, and/or user information, one or more candidate payment instruments available to the user and suitable for purchase transactions at the merchant. As described above, the user may register for online banking at the financial institution through a corresponding digital portal, and during the registration process, the user may identify one or more credit cards, debit cards, and loyalty or rewards cards held by the user. For example, the user may register for online banking at TD Bank™ through a corresponding web page, and may populate a user profile with information identifying a credit card issued by TD Bank™, a TD Bank™ debit card linked to a checking account, and further, an account number of a Starbucks™ reward program. Further, in some aspects, transaction server 142 may be configured to process the user's stored account data (e.g., within account data 144B) and stored transaction data (e.g., within transaction data 144C) to identify additional or alternate payment instruments available to the user. For instance, transaction server 142 may process the user's transaction data to identify an American Express™ credit card held by the user (e.g., based on “pull” transactions satisfying a monthly statement). Transaction server 142 may, in certain instances, be configured to store data linking the available payment instruments to the user within a data repository (e.g., cloud-based data repository 170 of FIG. 1).

Upon receipt of the payment instrument, merchant, and/or user information from POS 156, transaction server 142 may authenticate the user (e.g., against credentials stored in customer data 144A), and may access cloud-based data repository 170 to obtain information identifying the payment options available to the user. For example, as described above, transaction server may obtain, from cloud-based data repository 170, information identifying the TD Bank™ credit card, the TD Bank™ debit card, the American Express™ credit card, and the Starbucks™ reward program held by the user. In certain aspects, transaction server 142 may filter the available payment and loyalty instruments according to the received merchant information. For example, based on the merchant information, transaction server 142 may determine that POS 156 is disposed at a Harris Teeter™ grocery store and further, that the Starbucks™ rewards card would not be usable for purchase transactions at the Harris Teeter™ grocery store. Transaction server 142 may, in some aspects, package information identifying the available and relevant TD Bank™ credit card, TD Bank™ debit card, and the American Express™ credit card for transmission to POS 156.

POS 156 may render the received information and present information identifying the available payment instruments to the user (e.g., through display 305). By way of example, POS 156 may present a list of the available TD Bank™ credit card, TO Bank™ debit card, and the American Express™ credit card to the user, and the user may select one of the available payment instruments for use in purchase transactions at the Harris Teeter™ grocery store. For example, through a touchpad or keypad of POS 156, the user may select the TD Bank™ debit card for use in purchase transactions at the Harris Teeter™ grocery store, and POS 156 may transmit information identifying the selected payment instrument to transaction server 142, which may complete the initiated purchase transaction using the TO Bank™ debit card (or forward information facilitating completion to the issuer).

In some aspects, may also rank or prioritize the available payment instruments prior to providing the available payment instrument information to POS 156. For instance, transaction server 142 may determine that the user received enhanced loyalty points when using the available American Express™ credit card for purchase of groceries, and the available payment instrument information may include instructions that cause POS 156 to highlight the available American Express™ credit card within the displayed payment instruments. Further, in some instances, transaction server 142 may determine an order of the available payment instruments based on a balance available on each of the available payment instruments (e.g., the available payment instrument information includes instructions causing POS 156 to high the TD Bank™ credit card, which has an especially large available balance). Further, in some instances, transaction server 142 may determine a level of risk of a location associated with POS 156 (e.g., based on reported instances of fraudulent activity stored in database 144 or obtained from a third-party or law enforcement agency associated with server 160), and may highlight or prioritize certain payment instruments appropriate to the determined level of risk.

In the embodiments described above, reference is made to a point-of-sale (POS) terminal (e.g., POS 156) that corresponds a physical device in communication with a corresponding network. The disclosed embodiments are not limited to such physical POS devices, and in further embodiments, the POS terminals may a include “virtual” POS terminal that corresponds to a software modules executed by, among other things, merchant server 152 and one or more of client devices 102, 104, and 106 in FIG. 1. Further, in additional embodiments, POS 156 may represent a device communicatively coupled to one or more of client device 102, 104, and 106 (e.g., a Square™) to provide mobile point-of-sale and payment services.

Reference is also made here to a server associated with a provider of the POS terminal (e.g., transaction server 142) that determines whether the provider corresponds to an issuer of a payment instrument, and, identifies various services available to the user based on the determination. The disclosed embodiments are, however, not limited to server that perform such functions, and in additional embodiments, a virtual or physical POS terminal, e.g., POS 156 of FIG. 1, may perform all or part of the functions described above in reference to FIG. 4, without departing from the spirit or scope of the disclosed embodiments. In additional embodiments, POS 156 may discern whether a POS provider corresponds to an issuer of a payment instrument, and further, POS 156 may identify default services may include advertisements or offers to take advantage of basic banking functions (e.g., balance inquiries, etc.).

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the invention being indicated by the following listing of exemplary claims.

What is claimed is:

1. A system, comprising:
a storage device; and
at least one processor coupled to the storage device, the storage device storing software instructions for controlling the at least one processor when executed by the at least one processor, and the at least one processor being operative with the software instructions and configured to:
receive first information identifying a purchase transaction involving a payment instrument of a user and second information identifying a point-of-sale terminal, the payment instrument being associated with an account of the user;
determine, based on the first and second information, whether an issuer of the payment instrument corresponds to a provider of the point-of-sale terminal;
when the issuer fails to correspond to the provider, request, from a server associated with the issuer, third information associated with a plurality of first services offered by the issuer;
identify at least one of the first services available to the user based on at least one of the first information, the second information, or user profile information; and
generate a first electronic command to transmit information identifying the at least one available first service for presentation on the point-of-sale terminal.

2. The system of claim 1, wherein the at least one processor is further configured to:
assign rankings to a plurality of the available first services in accordance with the user profile information and a rule established by at least one of a merchant or a financial institution;
select at least one of the ranked available first services for presentation to the user; and
generate a second electronic command to transmit, to the point-of-sale terminal, information identifying the selected ranked available first services.

3. The system of claim 1, wherein the profile information comprises at least one of:
demographic data associated with the user;
information identifying one or more additional accounts associated with the user;
information identifying a responsiveness of the user to one or more previously provided services;
information identifying a lack of responsiveness to one or more of the previously provided services;
information associated with a credit history of the user;
information identifying a user preference for a maximum number of first and second services; or
information identifying a user preference for a maximum number of daily transactions for which the point-of-sale terminal provides first and second services.

4. The system of claim 1, wherein the first services comprise at least one of:
obtaining a statement associated with the user account;
obtaining information identifying a plurality of transactions associated with the user account;
obtaining information identifying a balance of available funds associated with the account;
obtaining a new account associated with the issuer;
activating a new account associated with the issuer; or
initiating a transfer of funds between accounts associated with the issuer;
providing a reminder of an appointment involving a representative of the issuer;
an operation that resets an authentication credential of the user;
obtaining a physical card corresponding to the payment instrument

5. The system of claim 1, wherein:
the purchase transaction is associated with a corresponding purchase amount; and
the at least one processor is further configured to:
determine whether the purchase amount exceeds a balance of the user account; and
establish an overdraft event when the purchase amount is determined to exceed the user account balance; and
in response to the established overdraft event, identify, as one of the first services, processes that provide overdraft protection associated with at least one of the user or the user account.

6. The system of claim 1, wherein at least one of the first services comprises an operation to complete a pending application for credit associated with the issuer.

7. The system of claim 1, wherein the at least one processor is further configured to:
receive a response to the provided information, the response comprising a selection of one of the first services;
generate a second electronic command to provide the selected first service to the user based on at least the received response.

8. The system of claim 1, wherein the at least one processor is further configured to:
receive a response to the provided information, the response comprising a selection of one of the first services;
generate an alert associated with the selected first service, the alert requesting at least one of an authentication credential from the user or a verification of the selection and
in response to the selection, generate a second electronic command to transmit the generated alert for presentation at the point-of-sale terminal.

9. The system of claim 8, wherein the at least one processor is further configured to generate a third electronic command to transmit the generated alert for presentation at a device of the user, the generated alert comprising at least one of an email message or a text message.

10. The system of claim 1, wherein the at least one processor is further configured to:
identify a plurality of candidate payment instruments available to the user based on at least one of the first information, the second information, and the profile information;
generate a second electronic command to transmit information identifying the at least a portion of the available candidate payment instruments for presentation at the point-of-sale terminal;
receive information identifying a selection, by the user, one of the candidate payment instruments; and
perform operations that execute the purchase transaction using the selected candidate payment instrument.

11. The system of claim 1, wherein the at least one processor is further configured to:
identify an alert condition associated with at least one of the user or the user account, the alert condition comprising at least one of a status of the user account, a credit limit associated with the user account, an expiration of the user account, or a balance of the user account; and
generate electronic instructions to transmit, to the point-of-sale terminal, information associated with the alert condition.

12. The system of claim 11, wherein the at least one processor is further configured to:
receive a response to the alert condition information, the response comprising a request to cancel the purchase transaction; and
cancel the purchase transaction based on the received response.

13. The system of claim 1, wherein the at least one processor is further configured to:
identify an offer associated with at least one of the user, the user account, or the transaction, the identified offer comprising at least one of a coupon, a discount, or an offer to redeem a reward from a loyalty program;
generate electronic instructions to provide, to the point-of-sale terminal, information associated with the identified offer.
receive information indicative an acceptance of the identified offer; and
in response to the acceptance, modify a parameter of the transaction in accordance with the identified offer.

14. The system of claim 1, wherein the at least one processor is further configured to:
determine whether a number of the first services exceeds a threshold number of services; and
when the determined number fails to exceed the threshold number of services, identify one or more second services, the second services comprising a default service.

15. The system of claim 1, wherein the at least one processor is further configured to:
detect a bandwidth characteristic of a communications network connecting the point-of-sale network and the system; and
selecting at least one of the first services for presentation at the point-of-sale terminal based on the detected bandwidth condition.

16. A computer-implemented method, comprising:
receiving, by at least one processor, first information identifying a purchase transaction involving a payment instrument of a user and second information identifying a point-of-sale terminal, the payment instrument being associated with an account of the user;
based on the first and second information, determining, by the at least one processor, whether an issuer of the user account corresponds to a provider of the point-of-sale terminal;
when the issuer fails to correspond to the provider, requesting, by the at least one processor from a server associated with the issuer, third information associated with a plurality of first services offered by the issuer;
identifying, by the at least one processor, at least one of the first services available to the user based on at least one of the first information, the second information, or user profile information; and
generating, by the at least one processor, a first electronic command to transmit information identifying the at least one available first service for presentation at the point-of-sale terminal.

17. The method of claim 16, wherein the identifying comprises:
assigning rankings to a plurality of the available first services in accordance with the user profile information and a rule established by at least one of a merchant or a financial institution; and
select at least one of the ranked available first services for presentation to the user.

18. The method of claim 16, wherein:
the profile information comprises at least one of:
demographic data associated with the user;
information identifying one or more additional accounts associated with the user;
information identifying a responsiveness of the user to one or more previously provided services;
information identifying a lack of responsiveness to one or more of the previously provided services;
information associated with a credit history of the user;
information identifying a user preference for a maximum number of first and second services; or
information identifying a user preference for a maximum number of daily transactions for which the point-of-sale terminal provides first and second services;
wherein the first services comprise at least one of:
obtaining a statement associated with the user account;
obtaining information identifying a plurality of transactions associated with the user account;
obtaining information identifying a balance of available funds associated with the account;
obtaining a new account associated with the issuer;
activating a new account associated with the issuer;
initiating a transfer of funds between accounts associated with the issuer;
providing a reminder of an appointment involving a representative of the issuer;
an operation that resets an authentication credential of the user; or
obtaining a physical card corresponding to the payment instrument.

19. The method of claim 16, wherein:
the purchase transaction is associated with a corresponding purchase amount; and
the method further comprises:
determining whether the purchase amount exceeds a balance of the user account; and
establishing an overdraft event when the purchase amount is determined to exceed the user account balance; and
in response to the established overdraft event, identifying, as one of the first services, processes that provide overdraft protection associated with at least one of the user or the user account.

20. The method of claim 16, wherein at least one of the first services comprises an operation to complete a pending application for credit associated with the issuer.

21. The method of claim 16, further comprising:
receiving a response to the provided information, the response comprising a selection of one of the first services;
generating an electronic command to provide the selected first service to the user based on at least the received response.

22. The method of claim 16, further comprising:
receiving a response to the provided information, the response comprising a selection of one of the first services;
generating an alert associated with the selected first service, the alert requesting at least one of an authentication credential from the user or a verification of the selection; and
in response to the selection, generating a second electronic command to transmit the generated alert for presentation at the point-of-sale terminal.

23. The method of claim 22, further comprising generating a third electronic command to transmit the generated alert for presentation at a device of the user, the generated alert comprising at least one of an email message or a text message.

24. The method of claim 16, further comprising:
identifying a plurality of candidate payment instruments available to the user based on at least one of the first information, the second information, and the profile information;
generating a second electronic command to transmit information identifying the at least a portion of the available candidate payment instruments for presentation on the point-of-sale terminal;
receiving information identifying a selection, by the user, one of the candidate payment instruments; and
performing operations that execute the purchase transaction using the selected candidate payment instrument.

25. The method of claim 16, further comprising:
identifying an alert condition associated with at least one of the user or the user account, the alert condition comprising at least one of a status of the user account, a credit limit associated with the user account, an expiration of the user account, or a balance of the user account; and
generating electronic instructions to transmit, to the point-of-sale terminal, information associated with the alert condition.

26. The method of claim 25, further comprising:
receiving a response to the alert condition information, the response comprising a request to cancel the purchase transaction; and
cancelling the purchase transaction based on the received response.

27. The method of claim 16, further comprising:
identifying an offer associated with at least one of the user, the user account, or the transaction, the identified offer comprising at least one of a coupon, a discount, or an offer to redeem a reward from a loyalty program;
generating electronic instructions to provide, to the point-of-sale terminal, information associated with the identified offer.
receiving information indicative an acceptance of the identified offer; and
in response to the acceptance, modifying a parameter of the transaction in accordance with the identified offer.

28. The method of claim 16, further comprising:
determining whether a number of the first services exceeds a threshold number of services; and
when the determined number fails to exceed the threshold number of services, identifying one or more second services, the second services comprising a default service.

29. The method of claim 16, further comprising:
detecting a bandwidth characteristic of a communications network connecting the point-of-sale network and the system; and
selecting at least one of the first services for presentation at the point-of-sale terminal based on the detected bandwidth condition.

30. A device, comprising:
a display unit;
a storage device; and
at least one processor coupled to the display unit and storage device, the storage device storing software instructions for controlling the at least one processor when executed by the at least one processor, and the at least one processor being operative with the software instructions and configured to:
receive, from a system associated with a provider of the device, information identifying a plurality of services available to a user, the available services being identified based on at least one of a payment instrument of the user, a purchase transaction involving the payment instrument, or a profile of the user, and the available services comprising at least one of a first service identified by the provider system and a second service identified by a system associated with an issuer of the payment instrument;
generate a first electronic command to present, to the user on the display device, data identifying a portion of the available services;
generate a second electronic instruction to modify a visual characteristic of the displayed data corresponding one or more of the available services in accordance with a characteristic of a communications network interconnecting the device and the provider system;
receive, from the user, a selection of at least one of the available services; and
generate a third electronic command to transmit information identifying the selected at least one available services to the provider system across the communications network.
